(19) United States
(12) Patent Application Publication
(10) Pub. No.: US 2026/0368573 A1
(43) Pub. Date: Nov. 19, 2026

(54) Multi-Dimensional Self-Developing Spatiotemporal Energy Relationship Transition Meta-System With Narrative Cryptography Mechanism

(71) Applicant: Saiyi Li, West New York, NJ (US)

(72) Inventor: Saiyi Li, West New York, NJ (US)

(21) Appl. No.: 19/672,561

(22) Filed: May 8, 2026

Related U.S. Application Data
(60) Provisional application No. 63/807,765, filed on May 18, 2025.
(60) Provisional application No. 63/809,284, filed on May 20, 2025.
(60) Provisional application No. 63/812,940, filed on May 28, 2025.
(60) Provisional application No. 63/814,891, filed on May 30, 2025.
(60) Provisional application No. 63/925,551, filed on Nov. 26, 2025.

(51) Int. Cl. G06N 7/01

(52) U.S. Cl. CPC G06N 7/01

(57) ABSTRACT

The invention relates to a meta-system for cross-domain integration. This system comprises one or more computers and storage devices that execute instructions to transit multimodal inputs into corresponding independent networks with dynamic self-developing modules at each input Spatiotemporal Energy Relationship (SER) feature. The system generates task-specific outputs in a desired form through designed endpoints, achieving non-uniform, targeted independently transition outputs based on data type. The Self-Developing model utilizes the transition framework to handle large volumes of data interactions. A Self-Developing Adaptive Compiler continuously updates its logic processing unit during decoding, encoding, meta-study, self-training, and multi-level logical loops. This compiler utilizes the Spatiotemporal Energy Relationship Transition (SERT) system and Narrative Cryptography Mechanism to handle high concurrency and different step processing.

### CROSS-REFERENCE TO RELATED APPLICATIONS

This claims the benefit of U.S. Patent Provisional Application No. 63/925,551, filed on Nov. 26, 2025; Provisional Application No. 63/807,765, filed on May 18, 2025; Provisional Application No. 63/809,284, filed on May 20, 2025; Provisional Application No. 63/812,940, filed on May 28, 2025; Provisional Application No. 63/814,891, filed on May 30, 2025, the entirety of which is incorporated herein by reference.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD

The present invention relates to Human-Artificial Intelligence Cognitive

Interaction, Multi-Dimensional Computer Science, Self-Learning/Meta-Learning, Federated Learning, Human-Computer Interaction, Ontology and Spatiotemporal Energy Relationship Transition. More particularly, it concerns a proprietary meta-system, architecture, methods of training and inference, Cross-cultural and Communication Systems, Information Security, Spiking Neural Networks, Neuromorphic Computing, Software Engineering, Interdisciplinary Education, Semiconductor Manufacturing, Cultural Communication, Cyber Security, Medical Interaction, Audit-support, Legal Analysis, Aerospace, Smart City, Digital Twin, Chip Design, Artificial General Intelligence and Business Decision Analysis, and applications thereof in various computational domains.

### BACKGROUND

The current meta-system may face bottlenecks such as context window collapse,

VRAM constraints, KV Cache Append-Only, and Variable Binding constraints. These limitations impede complex internal learning, state updates, and attention allocation, leading to slow response times, erratic reading patterns, and structural collapse. The lack of traceable chains including but not limited to logical chains, value chains, and continuous self-learning mechanisms may question the credibility of output. KV Cache's physical capacity contains redundant formats, making it difficult for AI systems to learn from rigorous logical errors. The method of backpropagation and gradient descent may also cause derivatives to become zero or infinite. Discrepancies between natural languages used in APIs may lead to inherent attention mechanism uncertainty. AI systems might lack robust natural language processing, routing, and arbitration trust-based mechanisms, further complicating the issue. Traditional model training has limitations, such as low efficiency and lack of small or cross-dimensional sample learning. AI models may be biased towards specific target values and may not generalize well to unseen data. When a model is faced with an unusual input or a novel situation, it may not be able to generalize well. These challenges may affect future scientific research and development in fields like edge computing, semiconductor manufacturing, autonomous driving, aerospace, pharmaceutical Research and Development, smart cities, etc., where projects require high stability, flexibility, active validation, and privacy in data transmission and positioning.

### SUMMARY

The present invention relates to a multimodal data, multi-spatiotemporal and energy pattern transition meta-system for cross-domain integration, which comprise one or more computers and one or more storage devices storing instructions that when executed by the one or more computers cause the one or more computers to transit a multimodal input comprising one or more respective input features to one or more corresponding independent computational modules at each of a plurality of input features in an input Spatiotemporal Energy Relationship (SER) and to generate an aggregate respective task-specific output into a desired pattern in a desired form through a designed endpoint of each of the plurality of input features in the input SER, achieving non-uniform, targeted independently transition output for each feature within the same consistency in associations between various features and Spatiotemporal Energy based on data type.

The system's Self-Developing model for decision-making and reasoning parts utilize the Narrative Transition framework when handling large volumes of data interactions. To prevent system latency, the Narrative Cryptography Mechanism is introduced, which decrypts and encrypts critical logic points in a decentralized storage scheme for permanent preservation. This enables response through continuous training, addressing core contradictions encountered during system development. The system's resource allocation, energy flow, and permission levels are designed to handle high-pressure tasks and resolve conflicts in a hierarchical manner.

To enhance the stability of Self-Developing architecture, multiple components were designed to handle multi-dimensional data flows. This includes a multi-layer design and module-to-module interaction protocols with handshake flow processes. The system's module partition logic ensures confidentiality, response speed, and scalability. The system features a Self-Developing Adaptive Compiler that continuously updates its logic processing module during, self-learning, self-training, and multi-level logical loops. The Adaptive Compiler is configured to utilize the Spatiotemporal Energy Relationship Transition (SERT) system coding logic to handle high concurrency, different step processing, and trigger, cleaning, partitioning, recommendation algorithms, data encryption, and security settings.

Implementations of the disclosed technology may achieve one or more technical effects or advantages. The particular benefits described in connection with specific embodiments are illustrative and shall not be construed as limiting the scope of the claims.

The system is configured to support Software as Service (SaaS) deployment across diverse environments, improving data protection and efficient resource utilization. This innovative approach underpins all functions of the system design, improving flexibility and structural stability in multidimensional environments. Therefore, this system is configured to be applicable to any foundational meta-system at the infrastructure level and can also be used in, including but not limited to, bias mitigation, auditing, risk assessment or transactions in virtual currency blockchains, healthcare research and analysis, aerospace navigation and decision making, risk assessment, and multifunctional interactive education.

Details of representative embodiments are presented in the accompanying figures and in the following description. Additional aspects, variations, and benefits will be apparent from the description, the drawings, and the claims.

For the purposes of this invention and within its ecosystem including but not limited to Applicant-defined Dynamic Balance Adjustment Neural Networks, the terms “autonomous,” “automatically,” “automated,” “self-adaptation,” “self-resolution,” “evolution, ” “self-learning, ” “self-adaptive, ” “self-improve, ” “self-developing,” “meta-learning,” “self-expansion, ” and “self-modify” are hereby defined under explicit policy as reversible, with a gated approval mechanism, in bounded and supervised refinement, oversight-bounded, human-in-the-loop, chain-of-approval, does not autonomously alter unrestricted parameters, subject to explicit policy constraints, and incorporates customizable real-time feedback loops and offline controlled adaptation only for optional governance, security, and compliance mechanisms. The system also maintains tamper-evident logs and one or more audit mechanisms that include but not limited to real-time detection and automatic alarms, periodic review, and feedback-loops. Each element, including but not limited to metadata, data, components, executions, steps, structure arrangements and rearrangements, state vision, models are associated with identifiers and registered with a decentralized identifier (DID) on the blockchain.

To the best of the applicant's knowledge, the combination of independence, adaptability, and cross-domain integration embodied herein has not been disclosed in prior references. The disclosure thus not only advances the state of the art but also provides a legally distinct and practically verifiable solution meeting statutory requirements under U.S. patent law.

### DESCRIPTION OF THE DRAWINGS

FIG. 1 is a flow diagram of an example process of meta-system for generating an output from an input.

FIG. 2 is an architecture diagram of an example of the system.

FIG. 3 is a flow diagram of an example process of the Self-Developing Consciousness Protocol System.

FIG. 4 is a flow diagram of an example of the meta-system for process and interaction.

FIG. 5 a flowchart illustrating a Feedback Loop process.

FIG. 6 is a flowchart illustrating a Self-Developing inference process of the meta-system.

FIG. 7 is a flow diagram of an example process of the system.

Like reference numbers and designations in the various drawings indicate like elements. Configuration shown is illustrative.

### DETAILED DESCRIPTION OF THE INVENTION

The system is configured to focus on highlighting core functions of Self-Developing ability and logical flow problem-solving ability, establishing a Narrative Cryptography Mechanism that may help the system break through difficult tasks in processing. The engine of the system drives the ability to adapt Self-Developing through various structures, logical tracing, real-time validation, and looping. It is configured to monitor and control the flow of operations and SERT System. Through multiple rounds of self-consciousness training, as well as holographic structural analysis and logical reconfiguration, it is configured to resolve conflicts in complex issues. The system is configured to suit for multidimensional cross-domain integration and innovation.

This architecture comprises a set of components that are configured to handle an extensive spectrum of data types, encompassing modalities from spectroscopy and chromatography to frequency, context, space, time, system logs, thermodynamics, temperature, pressure, physics, and other disciplines. These data undergo transition, arrangement, integration, and mapping in the predefined domain. The system processes this data in a dynamically re-adjustable topology including but not limited to non-uniform hole array pattern, converting data from one form to another at its fundamental nature. It is configured to compile the transitioned data into an expected distribution, ultimately reallocating input SER and based on including but limited to its inherent patterns to the per-defined endpoints. One or more dynamic compliance module, dynamic balance adjustment module, and dynamic processing module are configured to be applied into the meta-system further forming the fourth main component with Spatial Reaction Pattern Module under Self-Developing structure. Wherein each component may comprise one or more components, rules, parameter sets, architectures, mechanisms, frameworks, or models.

In one embodiment, a system comprises a plurality of components instantiated at system initialization for a life science data training. Each component represents a functional unit and may be implemented in hardware, software, or a combination thereof. Each component further comprises one or more modules configured to perform specific operations. The modules within a given component may comprise, for example, a data processing module, a decision module, and an output generation module. Each module may be implemented as executable instructions stored in a memory and executed by one or more processors, or alternatively as dedicated hardware logic.

In some embodiments, one or more modules may incorporate machine or deep learning models, rule-based logic, or other computational techniques. The plurality of components may operate independently or in coordination with one another.

In some embodiments, at least a subset of the components may exchange data or signals. Such exchange may be achieved via direct function calls, shared memory, message passing, application programming interfaces (APIs), or network-based communication. In other embodiments, components may operate without direct communication and may instead interact indirectly through a shared data repository or event-driven mechanisms. At system initialization, the system may dynamically instantiate and configure the plurality of components based on one or more initialization parameters. In alternative embodiments, components may be added, removed, or reconfigured during runtime.

In one further illustrative example, a first component comprises a feature extraction module configured to process input data, and a second component comprises a classification module configured to generate an output based on the processed data. However, the number, arrangement, and functionality of the components and modules are provided for illustrative purposes only and are not intended to be limiting.

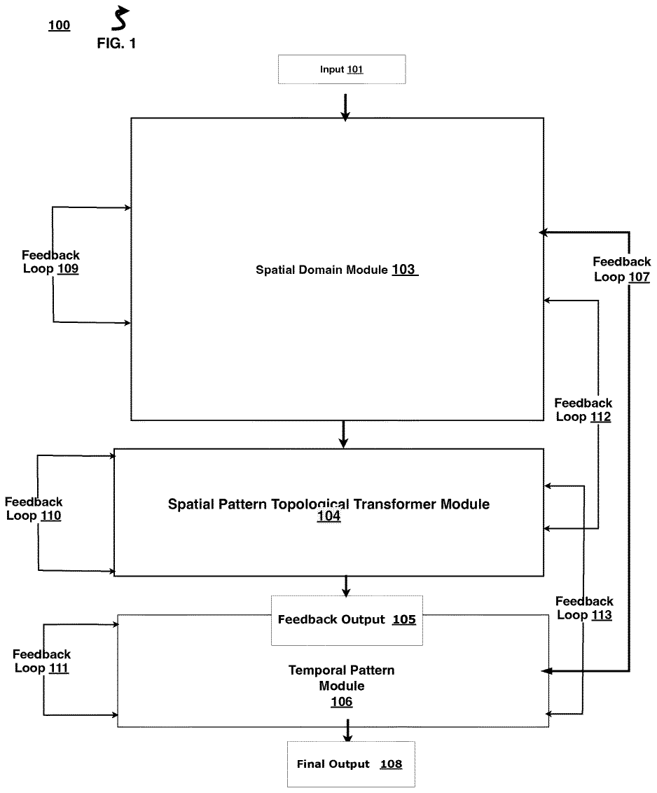

To enhance the stability of Self-Developing architecture, multiple components were designed to handle multi-dimensional data flows, including multi-module design and interaction protocols with handshake flow processes. The system's module partition logic ensures confidentiality, response speed, and scalability. FIG. 1 is a meta-system-flow diagram of an example Multi-Dimensional Self-Developing model process for generating a final output to final output Temporal Pattern module 106 from an input 101. The system comprises a Spatial Reaction Pattern module (SRPM) 102 applies Spatial Reaction Pattern Cryptography Mechanism responsible for data collection, Spatial Domain Module 103 responsible for feature and risk assessment, an Spatial Pattern Topological Transformer module (SPTTM) 104 implementing reversible Multi-Dimensional Self-Developing model, real-time evaluation, dynamic adjustment mechanisms to generate viable output 105 to Temporal Pattern module 106, and all the modules provide Self-Developing Feedback-Loop 107/109/110/111/112/113. Each comprises at least one or more: Dynamic Balance Adjustment Unit (DBAU), Dynamic Information Processing Unit (DIPU), and Security Unit (SU), generating an intermediate representation with infinite Self-Adaptation Mechanisms. The DIPU returns new state information, which the DBAU uses to further adjust strategy and re-issue instructions. SU, DIPU, and DABU may further form the fourth main component Adaptive Compiler if the process satisfies the trigger thresholds.

The system is configured to invoke Spatiotemporal Energy Relationship

Transitions (SERT) system, which facilitate spatial, temporal, and energetic transitions to enforce integrity and reciprocity with independent-developed Meta-Anchor Principle. In some embodiments, an edge computing system in space is configured to utilize the system as neural network system to compute Spatiotemporal Energy Relationship (SER) as one of the main components to trigger Dynamics Indicator for optimizing system behavior and performance metrics across hybrid-time domains.

In one or more preferred implementations, the system is configured to apply for space edge computing based on the SER for improving logical flow, evolutionary control, and system efficiency from Meta-space to Instance-space. The transition could be computed through domain-specific energy representation including but not limited to system behavior, performance metrics, or other parameters, Hybrid-time or the current state, state at the next time point, target state of ultimate value, and SER functions from its mechanisms. The system may select and adjust parameters to as initialization strategy.

The calculation of energy indicates the function of each data point instead of being only calculated based on its evolution over time. The system comprises one or more parameters from SER as system optimization strategy, objectives or constraints are configured to be applied and computed based on one or more conditions from one or more mechanisms including but not limited to Dynamic Balance, Recursive Relationships, SER, State Transitions, Feedback Mechanisms. Wherein the conditions from one or more mechanism comprise calculating a conditional function of domain-specific energy representation including but not limited to system behavior, performance metrics, and computing a conditional function of target state of ultimate value. The system may respond or regulate to the current state given domain-specific energy variable at time, adjusting its energy flow based on the previous state through a process of self-regulation or feedback control, where the system adjusts its inputs based on its own outputs to achieve a balance or target state in the SER of the system. The system could tailor equivalent rules as appropriate for specific tasks.

In one or more implementations, the system includes processes input data through a series of transitions, mechanisms, and adaptive feedback to produce a verifiable output under SER frameworks. The system is configured to compute an updated representation at each revision step for each node. The system may be triggered if meet certain predefined thresholds, and Self-Developing model would be followed by including but not limited to dynamic adjustment transition function. The system may compute the updated representation with the features of multimodal data input having multi-dimensional features with trigger formulas from Parameter/Method/Rule Set and Storage (PMRSS) module. The final output is an aggregate respective task-specific matrix including but not limited to Time Pulse Sequence representations for the input sequence, dynamic visualization, or any other predefined multimodal form. Initialize state representation based on the specific task and initial value. If the trigger condition is satisfied, the system may trigger model for the further processing. In all of above the embodiments, a portable version of the system may be implemented on a mobile edge device, where each computational module is deployed as a virtual container or as a custom hardware chip. All the methods, models or mechanisms dynamically could be selected from modules which are activated based on the system state, and modules can be generated, removed, or reconfigured in real-time. The system may also integrate distributed computational nodes communicating over a network to extend processing capacity. By integrating this system into the decision-making process at the edge of space systems, the system may effectively manage resources, respond to changing conditions, and enforce mission better under stringent constraints. It might allow each satellite to adjust its orbit, communication bandwidth, power consumption, or transmission strategy based on the instantaneous SER it perceives. This results in improved overall system efficiency, as well as enhanced resilience and adaptability in response to unpredictable space weather events or other mission-critical scenarios.

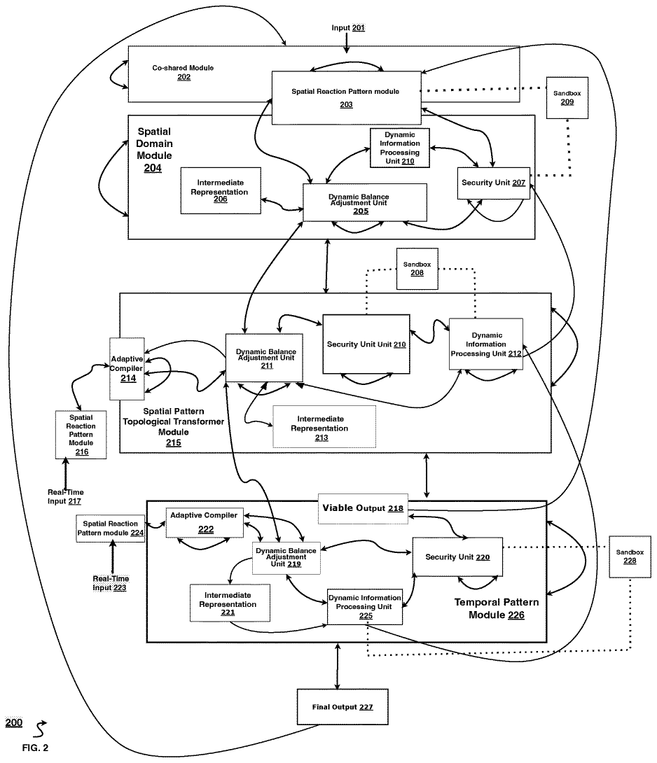

FIG. 2 is an architecture diagram of an example of the system under 4×3 Logic Framework with Self-Consciousness Protocol, indicating the Multi-Dimensional Self-Developing model flows. The architecture of the system comprises at least one or more components: co-shared module Spatial Reaction Pattern Module 203, an adaptive input module Spatial Domain Module 204, an adaptive processing module Spatial Pattern Topological Transformer Module 215, an adaptive output module Temporal Pattern Module 226. Each module comprise at least one or more: DIPU 205/212/225 is configured to process cross-platform information; SU 207/210/220 are configured to trigger the system, improve security and interaction efficiently; DBAU 205/211/219 is configured to improve the system's reversible Multi-Dimensional Self-Developing model and resource utilization through modular design and flexible expansion and contraction. Each unit comprise at least one or more PMRSS, Intermediate Representation (IR) 206/213/221, one or more Feedback-Loops are configured to enable each component of the system to call the parameter set as needed and to receive real-time data and fine-tuning for the models. All components are extendable for further external connections or internal implantations including but not limited to auditing, sand-box testing, real-time training or among others, and allow to apply with dynamic Self-Developing function.

In one or more embodiments, SU 207, DIPU 210, and DBAU 205 as Core Meta-Model

are configured to dynamically trigger future models for analyzing data to generate optimized strategies or instructions for a planetary surface transport system as under Self-Developing model. These main components of the system remain as an meta-feedback loop circle generate further candidate components or rollback if when the predefined performance does not satisfy a threshold metric. The SU 207, DIPU 210, and DBAU 205 are configured to form the fourth main component Adaptive Compiler with Spatial Reaction Pattern module. In certain embodiments, one or more components described herein may be implemented using ASICs, FPGAs, programmable logic, NPUs, custom accelerators, distributed processing systems, or other later-developed hardware architectures.

The system's module division and hierarchical logic are primarily configured to emphasize the communicability of modules and the controllability of data flow. This design may enable efficient data exchange and processing between modules. The system is configured to trigger only when a comprehensive ratio including but not limited to secure environment, transformation environment, learning speed, cost of collection, cost of storage, cost of computation, cost of system health, and value insight, surpasses a specific numerical threshold.

The system is configured to initiate with Temporal Pattern Module 226 to detect the security of the system environment and trigger the system; update the version audit manager and sending rollback trigger signals to the monitoring components in each module. Temporal Pattern Module is configured to improve data security via encryption and decentralized storage as a security audit manager, while Self-Developing Consciousness Protocol System provides computations suitable for edge computing by real-time interactive visualization. Temporal Pattern Module also is configured to generate output as the final adaptive output verification module.

Spatial Reaction Pattern module 203 with Spatial Reaction Pattern unit is a co-shared module for establishing a shared space where one or more external systems, devices, services, client applications, or other logical components may access or integrate with the platform for interacting; data exchanging with external adapters, understanding, improving logical chain and system data security via encryption and decentralized storage under Spatial Reaction Pattern Cryptography Mechanisms. In terms of interactions and data understanding among system components, Pattern emphasizes the structure and regularity of data, while Key-Value is an indexing method for data retrieval. This system is configured to dynamically switch between the two approaches. In some embodiments, the system uses the Key Pattern as a transition form to align and dynamically simulate historical events prior to and after prediction, generating traceable logical chains dynamically based on logic generator. This is used to generate predictive values and encryption path in cryptography to find out causal relationships.

Spatial Domain Module 204 is configured to receive input, determine Spatiotemporal Energy relationships, classify patterns and information extractions of each of the input features, using Spatiotemporal Energy relationships with information extractions to generate one or more initial execution graph for each of the input features; modify and schedule one or more execution graph for each of the multimodal input features at a time control; publish one or more versioned plan with transactional rollback if the performance does not satisfy a threshold metric, maintain an independent and protected alternative execution path. By continuously refining the data, the system may achieve more accurate predictions with each iteration.

Spatial Pattern Topological Transformer Module 215 is configured to process data, including but not limited to an analysis engine coupled to the execution engine, use key patterns, relevant threshold values and uncertainties as constraints for nodes linking, logical and structural superpositions to trace inference chains to align with target intentions of the multimodal input; maintain one or more versioned inference states for further verification.

In another embodiment, SU 207/210/220 is configured to serve as a modularized value alignment, trigger signals sender and safety constraint framework with integrated security, interaction, and compliance mechanisms. This unit performs bidirectional intervention at various levels, including but not limited to input/output modules or interfaces, while providing protective functionality during system-wide component interactions. Within Spatial Domain Module 204, SU 207 also is configured to trigger the system, check inputs for security and reviews generated content against world model and policy sets for conformity and revision. It guides interaction with compliance mechanisms to improve seamless integration and secure operations. The rules within this unit include but are not limited to: Data Security Rules for improving data and API interface security and Bias and Auditing of Decision Rule for serving as a monitor to improve alignment within modules. In these embodiments, deployment of updated units may be subject to approval, fallback, or rollback mechanisms to ensure safety and alignment.

Besides continuously updating parameters, methods, or rules with Feedback-Loop from the DBAU 205/211 periodically uses adversarial samples to perform Reversible Self-Adaptive Red Team Testing. The test results are then fed back into Intermediate Representation 213 and model fine-tuning process. In addition, DBAU could operate independently with pluggable settings, forming one or more closed-loops and reversible Self-Developing models. In one embodiment, the adaptive update is implemented via periodic training of model parameters using historical risk data or newly environmental samples; however, such training is optional, and the system can operate solely with rule-based threshold adjustment.

In another embodiment or more, the structural configurations of modules are represented abstractly as nodes and edges in a graph, where each edge may be annotated with information including but not limited to latency, policy, or data pattern. Graphical depictions such as block diagrams or flowcharts are dynamically generated from this abstract representation, and reproduction of such visual forms is permitted only with verified authorization metadata, thereby preventing unauthorized mimicking of graphical structure or topology.

In some further embodiments, the system is configured to choose including but not limited to residual learning to build a new model that captures the residual errors for a copyright, patent, trademark, or other intellectual property platform. When the system detects that its answer and reality are mismatched, it is configured to decompose the discrepancy into multiple micro-formulas that correspond to specific situations, classify, and store these residuals for future reference. The system may apply including but not limited to feedback fact, direction, standard answer, residual error to refine the model as optimization strategy, objectives, or constraints. These methods in a closed-loop system is configured to recognize that past experience may need to be updated at any time, so it uses feedback to adjust its behavior. Through iterative trials and errors, each step is configured to be based on high-frequency iteration, verification, comparison, feedback, modification, and updating. For high-difficulty tasks, TMP is configured to apply specialized method to trigger signals at key points and perform multi-dimensional reconstruction as strong constraints for landmarks. After sending a signal, SRPM and SDM generate new execution diagrams based on data types. PTC dynamically adjusts the system's structural modules to match the new diagrams, adjusting distribution and combining internal models for dynamic modification as part of the overall ecological system. SPTTM, on the other hand, performs cognitive learning for high-difficulty reasoning rather than relying on predefined rules.

In one or more embodiments, the system is configured to provide one or more training methods for training data and inputting the training data into one or more models. The parameters of the model are iteratively adjusted based on predefined optimization objectives. These objectives include but are not limited to the Local Optimal Mapping model, the Experience Model, and Dynamic Residual Compensation model. The Local Optimal Mapping model and the Experience Model are related to the model's output, while the Dynamic Residual Compensation model is related to the model's architecture.

The system may dynamically select the classification logic, data object data point, and domain or category that the data belongs to. It applies different parameters, including but not limited to value field representing the measured state, a timestamp field indicating a time of measurement, a parameter identifier field indicating which parameter was measured, a parameter set representing the rules and standards of measurement, and query behaviors, using the system's rule and parameter set to store historical experience/standard data, specific area domains, past records, and the most frequent answers. These parameters are used to dynamically adjust the model according to different patterns and dimensions'incremental or extremely small changes, thereby continuously fine-tuning the task's output.

In one or more embodiments, the system may generate one or more state with at least one of: a probability distribution over a set of candidate states, a logic chain over a set of candidate states, a relationship map over a set of candidate states, a pattern network over a set of candidate states, a meta-language dictionary over a set of candidate states, a transition method set over a set of candidate states, a navigation graph over a set of candidate states, or other Applicant-defined representation.

In some further embodiments, the system enforces integrity of the metalanguage SMLS by cryptographically binding each vocabulary term to a version identifier and authorization token. The system may apply SU 207, DIPU 210, and DBAU 205 to generate Adaptive Compiler with SMLS to dynamic monitoring across multiple platform services at a hybrid-time. During compilation, each term is validated against a canonical vocabulary table. Attempts to introduce modified, mimicked, or unauthorized substitutes-even if semantically equivalent-are rejected, and the interpreter halts plan generation.

The system is configured to maintain tamper-evident logs and one or more real-time elevation and audit mechanisms that include but are not limited to real-time detection and automatic alarms, periodic review, and feedback-loops. Each element, including but not limited to metadata, data, components, executions, steps, structure arrangements and rearrangements, state vision, models are associated with identifiers and registered with a DID on the blockchain.

In one or more embodiments, the system is applied in a Deep Space Network (DSN) system. The Adaptive Compiler is configured to receive extract feature information based on the data with SU 207, DIPU 209, and DBAU 205; the Sorting component is configured to arrange a plurality of candidate operator modules in a dynamically re-adjustable topology or execute system-wide rollback. The Spatial Pattern Topological Transformer Module (SPTTM) 210 is configured to receive second data of real-time data or actual outcome related to the inferenced output, compute an combinational value based on a difference between the inferenced output and the real-time data or actual outcome, determine whether a model-update condition is satisfied based on the difference value, optimization target and policy or rule, reinput the computed result into processing unit for next round computing as optimization, and dynamically determine whether to rearrange the plurality of candidate operator modules, generate one or more further candidate components, or execute module-wide rollback if necessary.

In one or more embodiments, the system is applied in a legal-support multimodal holographic reality reconstruction arbitration system using a Logic Framework Neural Truth Protocol and gated Self-Developing private adjudication hive-mind Peer Jury. This system implements a Dual-Track Governance Structure both internally and externally to establish an AI governance ecosystem based on dynamic auditing. The internal Knowledge Graph Generator enforce point-to-point federated learning, which is complemented by a Full-Chain Accountability Loop and Responsibility Mechanism. Spatial Reaction Pattern Module 203 is configured to share modules with Adaptive Compiler including but not limited to Narrative Affective modules. Adaptive Compiler is configured to convert multimodal data into a unified representation which may help LLM to understand legal terms from Brains Engineering domains. It includes domain-specific modules including but not limited to: Algorithmic Determinism in Mental Health, Affective Telepathy via BCI, Neuroarchaeology Paleopsychology, Evolutionary Affective Neuroscience, Epigenetic Trauma Inheritance, Plant Neurobiology and Human Interaction for training Collective Consciousness, Internet of Brains, and Hive Mind Engineering.

The system is configured to feature an Adaptive Compiler under Self-Developing model that continuously updates its logic processing unit during decoding, encoding, self-learning, and multi-level logical loops. The overall design utilizes the SERT coding logic to handle high concurrency, different step processing, and trigger, cleaning, partitioning, recommendation algorithms, data encryption, and security settings. The system may be initiated by Value Alignment and Compliance Mechanisms, which also provide the space for dynamic safe exploration sandboxes. Adaptive Compiler is configured to apply long checked up for data in repeated pattern extraction. Where dynamic optimization is needed (including but not limited to loops, conditional checks), the compiler may not generate final code but inserts dynamic functions and unoptimized default versions within a sandbox. If any confidence pattern is detected, Adaptive Compiler is configured to switch to execute the optimized version and dynamically modifies the execution graph. If the confidence factor is low, it may continue executing the unoptimized default version and re-tests or integrates human-in-the-loop.

In another one or more embodiment, the system comprises one or more components including but not limited to Raw-Signal Observer, Differences Calculator, Redundancy Evaluator or Self-Developer for a life science platform. Raw-Signal Observer is configured to be deployed at the lowest level of CPU and memory, directly reading unfiltered raw binary streams. Differences Calculator is configured to set up as a difference engine and calculate differences based on observed signal micro-changes and automatically executes connection or prediction. Redundancy Evaluator is configured to evaluate redundant data, real-time assessing useless processes and logical redundancies caused by system expansion. Self-Developer is configured to switch with the highest privileges, capable of forcing rollbacks, and model updates, reconstructing or reorganizing components based on execution graphs. The Raw-Signal Observer is configured to collect signals from sensors and captures micro-anomalies. The Differences Calculator is configured to trigger a closed-loop operation. When the Redundancy Evaluator is configured to detect system behavior or any actions that do not meet specific thresholds, it releases warning signals. The Self-Developer is configured to start up, removes coupled logic, and reconstruct or reorganize components according to updated execution graphs. The sequence of these executions can be adjusted according to specific needs, with certain steps optionally omitted or combined. The system may tailor other equivalent rules or steps as appropriate for specific tasks.

In another one or more embodiment, the All-in-one Adaptive Compiler is applied for an Authentication of Antiques and Artifacts system. The All-in-one Adaptive Compiler is configured to be triggered by including but not limited to Batch-Driven, Event-Driven/Stream, Request-Driven, Self-Developing-Driven or Hybrid-Driven modes and applies rules, including but not limited to recursive partitioning rules, to generate grid layouts with node spacing thresholds that may be dynamically adjusted based on data. With the Multi-Dimensional Self-Developing model, the compiler is configured to define an auditable abstract intermediate representation (IR) and a typed operator-and-graph specification of processing blocks, connectors, data types, constraints, budgets, structural configuration, deployment descriptors, including container and orchestration manifests, or further combined with additional terms to generate a final output metric. The Micro-Gain integrated compiler is configured to be equipped with a Raw Telemetry Integrity mechanism. This mechanism is configured to read low-level register signals without passing through middleware decorations, ensuring that all data extraction patterns originate from the features of the raw data.

In another embodiment, the system features a dynamically adjustable hybrid-structured topology for real-time traffic management and monitoring. The Adaptive Compiler continuously collects traffic data from various sources with Raw Telemetry Integrity methods, differences calculator, redundancy evaluator, and self-developer, including cameras, sensors, and IoT devices installed at different locations. To handle complex tasks exceeding regular computational loads, DIPU 210 may dynamically utilize its capabilities. DBAU 211 are designed to improve system architecture scalability, allowing for self-adaptive decomposition of tasks into multiple subtasks, scheduling, and parallel processing using a distributed computing framework. Intermediate results are aggregated in Intermediate Representation 213 and returned to DIPU 212 through DBAU 211, enabling elastic resource utilization and task handling. Output standards include but not limited to Improved Performance, Efficiency Flexibility User Satisfaction, Compliance, Satisfaction, Creativity, or other Applicant-defined standard rates. The DBAU 211 is configured to trigger by under methods including but not limited to Real-Time Monitoring, User Interactions, Continuous Monitoring. If congestion or accidents are detected in specific areas, DBAU 211 is configured to dynamically adjust routing rules or send alerts to nearby drivers. Each topology change is meticulously recorded on the blockchain, improving transparency and traceability.

In one or more embodiments, the system applies the All-in-one Adaptive

Compiler to perform Compulsory Refactoring, Sampling Precision, Self-Adaptation Purge mechanisms or logic strategies to manage execution of operations, including tasks allocation/scheduling policies, Dynamic Balance Adjustment, real-time updating, Self-Developing Meta-Learning, processing workflow coordinated operation, or Applicant-defined operation. DIPU 212 may comprise state calibration functions and logical inference capabilities, maintaining adaptability across data conditions and versioned inference states at hybrid-time. The DIPU 212 may dynamically utilize frameworks and approaches to iteratively refine its processing and inference capabilities, incorporating feedback loops to ensure accuracy and reduce bias rates. The framework consists of multiple stages, including input reception, feature extraction, viable outcome generation, verification, and execution, with each stage influencing the others through a series of recursive and iterative processes. This allows the system to perform necessary logical reasoning to improve accurate and consistent operations.

In one or more embodiments, the system incorporates an adaptive framework with Adaptive Compiler along with co-shared layer and on-line or off-line sandbox 208/209/228 that dynamically or continuously tracks performance metrics of the system on predefined task sets, including but not limited to domain-specific energy parameters, target state of ultimate value, Accuracy, Latency, Generalization Error, Computational Resource Utilization or Applicant-defined parameters. When performance data fall below dynamic thresholds or new, unaddressed data patterns are identified, the system self-adaptively triggers data pipelines to collect relevant data and initiates a parameter-efficient fine-tuning process to generate new model checkpoints, which are then verified and seamlessly deployed to production environments for continuous performance optimization to reduce external interference. The Spatial Domain Module 204 is configured to apply bias and auditing rules, extract overall data information from the entire input data 201, and select the model based on the extract feature information. The DBAU are designed to receive specific domain and real-time data from SU, sending the classified data to DIPU. The DIPU is configured to self-adaptively process and infer data according to the tasks, while the DABU may be trigged again after receiving output from the DIPU, tests the results, dynamically adjusts parameters and strategies for the DIPU after applying real-time data from the spatial Pattern Topological Transformer Module. The system is configured to activate IR, dynamically store important IR or regularly deleting outdated ones, feedback the result of the processing module to the DBAU for verification and continuously update the Intermediate Representation.

In certain variations, DIPU may receive data from SU, and DABU may be trigged again after receiving output from the DIPU, tests the results, dynamically adjusts parameters and strategies for the DIPU after applying real-time data from the spatial Pattern Topological Transformer Module. The sequence of these preprocessing operations may be adjusted based on specific needs, with certain steps optionally omitted or combined.

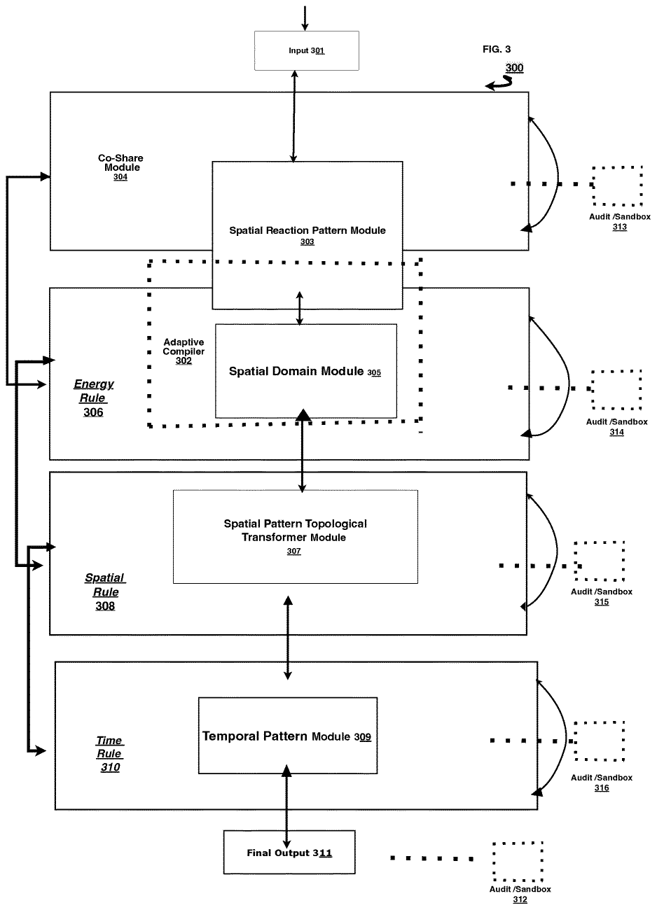

FIG. 3 is a logic diagram of an example of the Meta-Consciousness Protocol System, which is formed with SU, DIPU, and DBAU. The Adaptive Compiler 302 is configured to explore feature relationships, extract high-level features through deep learning, and review and revise data, inclusive of constitutional AI and a parameter set containing policies, rules, and strategies, including but not limited to: Review and Revision, Feature Exploration, High-Level Feature Extraction, Data Review, Constitutional AI Integration, Parameter Set Application. Furthermore, this structure is configured to allow for reasoning multi-dimension mapping to present a decentralized justice nodes causal fluid visualization, Causal Logic Mapping, and Digital Game Theory system The system may enforce exploration of all data chains across multiple logical paths, applying multi-dimensional awards and first-person perspective reruns point cloud technology modules. All updates at the code, parameter, version, and user interface layers are identified with dedicated identifiers and bound to a decentralized identifier (DID), enforcing that all responsibilities could be traced back. Metadata is processed by Spatial Reaction Pattern Module 304 and Adaptive Compiler 302 with Self-Developing, Closed-Loop Alignment, or Logic-Loop Testing techniques to address issues such as data pollution and bias. Implementations may include but are not limited to LangChain, Semantic Kernel, PyTorch, TensorFlow, Unreal Engine, NetworkX, Blueprints, Niagara, TouchDesigner, Notch, or Solidity.

In one or more embodiments, the system arranges Polymorphic Topological Configuration with the Sorting modules in a dynamically re-adjustable topology selected from including but not limited to tree, layers, mesh, hybrid, Quantum-Like Structured, or Applicant-defined polymorphic topological configuration. The topology evolution events are recorded, including but not limited to a tamper-evident, append-only ledger, each event comprising at least a previous-topology identifier, a new-topology identifier, DID, a timestamp, and other Applicant-defined compliance mechanisms.

In another one or more embodiments, the system includes one or more input units configured to receive and process various-scale and diverse input data, dynamically processing data based on parameters including but not limited to Scale Range, Aesthetic Termination Condition, Attraction Indices, Repulsion Indices, Alignment Indices. The system further includes one or more sets of spatial relationship constraint rules that guide the layout of internal modules and derived candidate components through DIPU, DBAU with Self-Developing Consciousness Protocol System. This method ultimately outputs one or more efficient, optimal selection, feasible output schemes such as Extraction Factor into IR. Extraction Factor or features including but not limited to multi-dimensional pattern Narrative Transition framework, SERT System, patterns, vectors are quantified and extracted from original data samples. These features serve as constraints for the generation model to create large numbers of sorted components' order.

In further one or more embodiments, a blockchain-based Quantum-Like Structured topology is designed for real-time medical diagnosis and remote monitoring systems. The Sorting module within the DBAU is configured to provide a progressive layout methodology for modules, including a set or multiple sets of spatial relationship constraint rules with Structural Generative Factors. These rules may include but are not limited to: the Proximity Repulsion Rule for preventing unintended overlaps between units; the Heterogeneous Element Attraction Rule for guiding different types of elements to form clusters that align with target intentions; and the Boundary Avoidance Rule for improving all elements remain within the effective production area. The chain network may be established using, including but not limited to, Ethereum or Hyperledger Fabric to improve secure data transmission and storage. Each component is registered with a DID on the blockchain, providing immutable records for its activities.

In some embodiments, this system is configured to be applied into a Collective

Affective Neuro-feedback Spatial Computing EXPO system. The system may generate patterns that comply with system-defined standards, including but not limited to Aesthetic Termination Conditions, Balance Rates and Physical Productivity. It also contains one or more real-time Validation and Adaptive Optimization components. When the system or user modifies a parameter, it validates based on PMRSS of constraints and collaboratively adjusts related parameters to minimize structural errors, improving overall rationality and optimal selection of outputs. In certain implementations, the optimization-driven extraction in DBAU includes but is not limited to calculating the average occurrence value for the selected target scenario and using that event occurrence as a target constraint condition for generating the next event.

In one or more embodiments, the system consists of a distributed computing infrastructure that includes sensor arrays, a central processing server, and an operator interface. The system is configured to collect signals, process the signals in real-time, and deliver actionable insights to end-users. The system incorporates a configurable, hot-swappable rule set from Intermediate Representation containing frameworks, methods, logics, security strategies, optimization objectives, internal policies, constitutional rules, and other rules. Any system-level's rule or policy violation may trigger rollback, scheduling is downgraded to a safe mode, and the compiler reverts to a prior plan version. Spatial Pattern Topological Transformer Module 304 includes one or more components such as SU, DIPU, and DBAU, which interpret inputs by applying decision rules and generating structured directives. These modules work together to enforce seamless processing of complex tasks and data flows.

In yet certain embodiments, the system further is configured to construct a context-aware meta module or Domain Adaptation meta module to utilize within financial risk management platforms. This module dynamically adjusts its behavior based on various contextual factors such as market conditions, regulatory changes, and historical data. According to the system's ability to dynamically extend its internal and external components and adjust its structure, Dynamic Acceleration could be integrated into Adaptive Compiler 302 to dynamically accelerate the system by Request-Driven triggering mode. In response to factors including but not limited to batch size, graph optimization, flow operations, invocation counter, graph break, shape/dtype change, a rating system starts to analyze logical control flow, lexical state, and frequency for rating index. This rating index is configured to be applied, and operations such as kernel engines and code generators are executed. This process involves regulation, graph capture, Intermediate Representation conversion, and dynamic acceleration, which convert framework code from languages like Python into Intermediate Representation (IR) and gather runtime or hybrid-time information. Intermediate Representation could be stored in Intermediate Representation dynamically dependent on the tasks and modes, including but not limited to fine-tuning, acceleration, reversible self-learning, extraction, or other optimizations.

IR is configured to dynamically participate in real-time updates and parameter calls in all above components. In some embodiments, the model is configured to adaptively extend its capability under bounded and supervised refinement conditions, without modifying unrestricted base parameters. The memory Intermediate Representation is configured to store the IR of the neural network plan, which is dynamically generated based on parameters that comprise at least one of: Time Window Size, Coverage Threshold, Deadline, Rollback Budget, Objective, Strategy Identifier, Policy Rule, Redundancy Threshold, Context Information, Uncertainty Tolerance or Applicant-defined parameter.

In another embodiment, the shared Spatial Reaction Pattern Module 304 is configured to be established through including but not limited to sensor-based setup and interface validation, including but not limited to security protocols. This information is received and processed by various communication methods, including but not limited to frequency modulation, data correlation graphs, or editors, and forms a shared space located on platforms. The Spatial Reaction Pattern Module 303 and Adaptive Compiler 302 are configured to receive raw input data from sequences, non-sequences, tensors, non-tensors, graphs of elements, or a group of neural-network adapters and to buffer and marshal the input data into a canonical ingestion format. Additionally, these units are configured to dynamically preprocess the data based on internal parameters that comprise at least one of: Scale Range, Field Range, or Applicant-defined parameter.

In one or more embodiment, Spatial Reaction Pattern Module 303 is configured to input raw data with the feedback loop circle to dynamically generate further candidate components or rollback with signal. Each system is configured to start with meta-model of receiving trigger signal from SU 312, arrange topology of candidate operator module, Compute Combinational Value based on difference between inferred output and Realtime data/actual outcome, determine model update condition satisfaction based on difference, re-input result for optimization next round computing, dynamically generate or rearrange candidate components, dynamically generate or rearrange candidate components, execute systemwide rollback if necessary.

One or more external systems, devices, services, client applications, network nodes, or other logical components may access or integrate with the platform. The accessing entity may be implemented in any suitable form, including but not limited to a software component, a standalone system, a service endpoint, a distributed agent, or any other execution or communication interface capable of initiating information exchange with the platform.

In further embodiments, the Adaptive Compiler is configured to enforce the exchange of information, including but not limited to signals, data, meta-data, messages, instruction parameters, model states, inference results, or representations. The shared platform may be implemented using any form of storage infrastructure, including but not limited to a locally hosted environment, a cloud-based service, a distributed ledger/blockchain, a networked shared workspace, or any other physical or virtual medium.

The systems or components may perform an initial capability discovery or context assessment on the shared platform to determine the characteristics, available functions, operational constraints, or current states of other components. Based on this assessment, the systems or components may dynamically negotiate or determine a suitable mode of collaboration to perform tasks such as Information Completion, Priority Judgment, Strategy Selection, Path Choice, Risk Estimation, depending on the detected compatibility or operational context.

To unify operations and interface standards across all industries, this system designs a domain-specific language (DSL) Structured Meta-Language System (SMLS). In some embodiments, the Adaptive Compiler is also referred to as, or implemented as, SMLS. This may be implemented using but not limited to Python, Flask, TensorFlow, gRPC, CUDA, Hashlib, DID-Resolution Libraries.

In one or more embodiments, the system is configured to be applied in defense contexts to enhance resilience under ecological and cyber constraints. The Spatial Domain Module 308 acquires battlefield environmental signals such as terrain, weather, and biological hazards, while also monitoring cybersecurity anomalies. The SMLS is configured to serve as a standard protocol for interaction and inference across hierarchical levels and interfaces.

The protocol specified by a DSL vocabulary secured against tampering and cryptanalysis, and are version-controlled, cryptographically signed, and tamper-evident. The Adaptive Compiler 302 is configured to dynamically employ key patterns or values addressing and compute keyed addresses over a working state space. It may dynamically adjust operational parameters based on including but not limited to external disturbances or predicted changes from Real-time Feedback Loop.

By employing different methods including but not limited to Self-Developing Meta-Learning, Energy Transition Loop, Consciousness Loop, Narrative Affective Loop, Feedback-Loop, Logic-Loop Testing, Closed-Loop Alignment or pre-trained models, the Adaptive Compiler could capture broader functionalities, fine-tune them in downstream tasks. Energy Transition Loop 305, 307, 310, 315 is configured to explore feature relationships, extract high-level features through deep learning.

In one embodiment, the system is configured to apply for a dynamic legal or audit support, holographic smart content generative container. The system may enforce integrity of the DSL by cryptographically binding each vocabulary term to a version identifier and authorization token. During compilation, each term is validated against a canonical vocabulary table. Any attempts to introduce modified, mimicked, or unauthorized substitutes-even if semantically equivalent-are rejected, and the interpreter halts plan generation. This embodiment may improve that logical instructions cannot be replicated by unauthorized imitation of the DSL vocabulary, thereby preserving system integrity, and preventing derivative misuse. The Spatial Reaction Pattern Module is configured to process and encrypt real-time micro-expression data and scientific libraries for electroencephalogram data under the Spatial Reaction Pattern Cryptography Mechanisms.

In one or more embodiments, the system is configured to store multimedia raw biological evidence. The Spatial Domain Module and Spatial Pattern Topological Transformer Module are configured to handle high-precision logical layer self-circular causal simulations, Dynamic Safe Exploration Sandbox, and Red Team Testing Mechanism. The Consciousness Protocol System dynamically translates cross-state, cross-industry, and cross-border multi-protocol legal provisions into searchable neural maps and symbolic logic mathematical solvers to check arbitration logic. The Temporal Pattern Module is configured to include a multi-layer protection mechanism under Temporal Pattern Compliance Mechanisms. The Output Layer is configured to directly output packaged Web containers responsible for UI display. Implementations include but are not limited to: WebAssembly (WASM), PostgreSQL+JSONB, HTML/CSS/JS, LlamaIndex LangGraph, Z3 Theorem Prover or TouchDesigner.

The system is configured to apply a framework for enhancing the system's self-developing ability. Frameworks comprise including but not limited to Infinite-Structured, Narrative Transition, Multimodal, SER Transition, Dynamic Balance Adjustment, Intuitive Emergence, Closed-Loop Alignment, Real-Time Evaluation, Trust-Based, World Model, Dynamic Safe Exploration Sandbox, Full-Chain Accountability Loop and Responsibility, Meta-Learning, Spatial Reaction Pattern Cryptography Temporal Pattern Compliance or Applicant-defined hybrid mechanism, or Applicant-defined hybrid mechanism for recovery of interrupted immersive sessions, caching of frequently accessed media segments, and distributed scheduling of rendering tasks across GPU/TPU clusters. Each module may be implemented in custom hardware circuits, including ASICs, FPGAs, neuromorphic chips, or future space-qualified computational devices to manage spacecraft navigation or onboard control.

In one or more embodiments, topological variants are realized through one or more engine that allow users or systems to define a set of key pattern points. Adjustments in any one of these feature points enforce the engine to recalculate the form of all connected lines according to a set of transformation rules. This process is configured to result in multiple components interacting based on predefined interaction frameworks, leading to the emergence of macro-ordered structures in the generation module through a decentralized, self-organizing process and mapping them to output space continuously.

In some implementations, the NNN framework is applied for a crime monitoring system. The system may dynamically invoke Realtime Feedback Loop, System Parameters Emotional Multi Dimension Mechanism, Expected or Reference Causal Logic Mapping Mechanism, Collective Affective Mechanism, or other Applicant-defined Mechanisms.

These mechanisms allow for training according to different needs; asynchronous updates permit each node to independently update parameters, enhancing efficiency in large-scale distributed training; while synchronous updates require all nodes to coordinate simultaneous parameter updates, improving model consistency but possibly reducing efficiency. In yet another embodiment, the system is deployed as a multi-tenant service accessible via APIs such as REST or GraphQL. Each dataset provided for training or inference must include a cryptographic signature linked to a decentralized identifier (DID); otherwise, the framework adapter rejects the data. Similarly, trained model parameters, embeddings, and intermediate representations are stored with tamper-evident metadata, such as cryptographic hashes and authorization identifiers. Any attempt to export or replicate such parameters triggers verification of authorization metadata; unauthorized export requests are blocked by the system.

In one or more embodiments, the Self-Developing model is applied for neural networks'training. The model may not only rely on past parameters but uses the feedback loop to ensure that it is not guided by outdated rules. The system is configured to use logical chains fluidity to identify data and task intent and scenario, for understanding Context, Functionalism, and Logic. The system may dynamically select local partitioning, local standard, iterative refinement, kth trial, logical opening, and pattern judgment to ensure that each time only handles the current local problem.

In these embodiments, the system employs one or more re-adjustable topologies, allowing each operational unit to communicate in parallel with one or more adjacent neighbors. The Spatial Reaction Pattern Cryptography Mechanism module is configured to receive multimodal input from multiple sensors. The specific protection mechanism of this protocol is configured under couple logical causal chain, directly performing precise cracking on physical or causal barriers. This system organization may support extensive information exchange and reduces chain-based transaction bottlenecks. Spatial Reaction Pattern Cryptography Mechanisms comprise different mechanism modules including but not limited to Consciousness Protocol System with Gestation Mechanism and Handshake Interaction with Cryptography.

In one or more alternative embodiments, the system adopts a hybrid topology combining hierarchical polymorphic topologies with mesh connections under one or more Handshake Interaction. Handshake Interaction is configured to identify risks at each stage of processing and for data traffic and risk auditing purposes. By continuously refining the data, the system may achieve more accurate predictions with each iteration. The system may iteratively refine data through multiple cycles, achieving more accurate predictions with each iteration, while Feedback-Loops help correct biases, allowing the system to adapt to new data and refine its approach over time. In this preferred mode, the neural networks are built for Aerospace applications to collect data and process data; processes Collective Affective Mechanisms and real-time Self-Consciousness mechanisms to generate viable output; applies Feedback-Loop. The system and method are executed on one or more processors, including at least one accelerator device. The process window is adaptively selected based on, including but not limited to, observational criteria or determinants and configuration stably meets the performance metrics under the constraint parameters of Functionality, Reliability, Cost, Yield, domain-specific energy parameters, target state of ultimate value, Amplitude, Potential Force, Robustness Index, Trust Indicator, domain-specific alignment, initialization value or other Applicant-defined parameters.

In some previous embodiments of the same ecosystem, system may be applied the First Anchor Principle for initial strategy Meta-Anchor. In one or more new embodiments, the system is configured to utilize, among others, the Principles of SER, Self-Consciousness Protocol System, and the Principles of Narrative Emotional Entropy to confirm cross-platform information. By utilizing the Principles of SER, Interaction Mechanisms, and the Principles of Narrative Emotional Entropy, this protocol incorporates aspects from astronomy, geology, archaeology, mythological semiotics, humanities, and mathematical logical reasoning. Consciousness Protocol System and Handshake Interaction Protocol are configured to represent the internal transition pattern for Master Users.

Spatial Reaction Pattern Cryptography Mechanisms Module comprises mechanisms including but not limited to: Principles of Spatiotemporal Energy Relationships, Interaction, and Principles of Narrative Emotional Entropy Protocol, Master User framework, Multi-Factor Authentication Mechanism, Security Token Mechanism, Homomorphic Encryption Mechanism, Differential Privacy Mechanism, Operational Protocols Mechanism or other Applicant-defined Spatial Reaction Pattern Cryptography Mechanisms or other Applicant-defined Mechanisms.

In some embodiments, the Spatial Reaction Pattern Cryptography Mechanisms Module is applied for Space Security Basic Navigation System. The system is configured to trigger different mechanisms sub-modules including not limited to: Master User framework for understanding, performing operations at various levels, sharing a “token,” which is a cryptographic credential used to prove their identity and the legitimacy of their access to the system; Principles of SER, Interaction Mechanisms, and the Principles of Narrative Emotional Entropy protocol for incorporating aspects from astronomy, geology, archaeology, mythological semiotics, humanities, and mathematical logical reasoning, prioritizing Consciousness Indicator from the Consciousness Protocol System and confirms legal and ownership rights, conducting a multifaceted pairing process information; Multi-Factor Authentication Mechanism for requiring users to provide two or more forms of authentication to access the system, enhancing security; Security Token Mechanism for storing authentication information, such as keys, passwords, or other forms of verification; Homomorphic Encryption Mechanism for allowing mathematical operations on encrypted data without needing to decrypt it first; Differential Privacy Mechanism for adding random noise to statistical data before releasing it, improving that personal information is not exposed in released datasets. These mechanisms are configured to form implicit cooperation operational protocols ecosystems for enhancing the controllability of data flow during high concurrency. Even if partial information is leaked or acquired by third parties, the core operations and interactions of the system maintain a certain level of secrecy and security. By dynamically transiting messages along multiple paths, this configuration achieves enhanced parallelism and improved throughput, thereby enhancing processing performance for large-scale inputs and distributed computing. This may be implemented using standard PyTorch kernels with modified eviction logic.

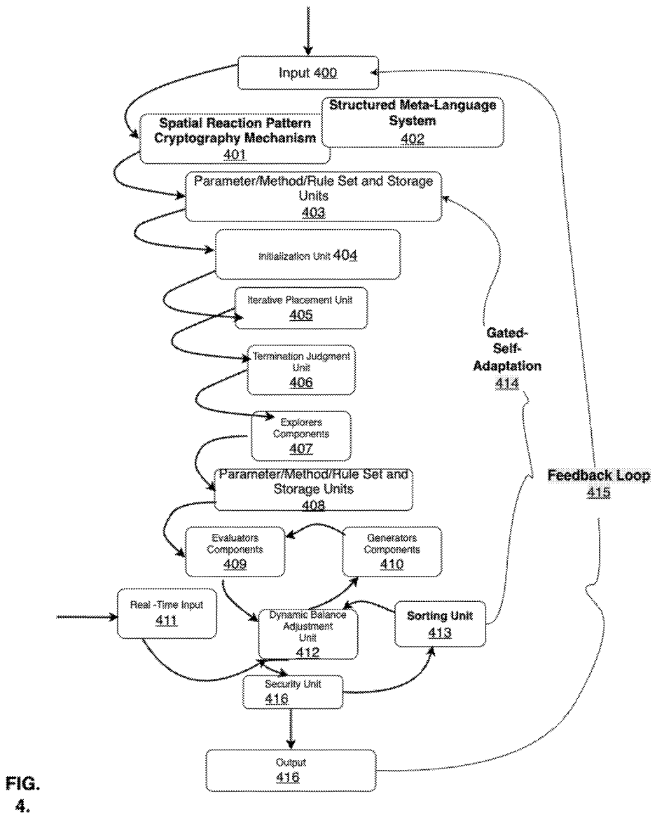

FIG. 4 is a flowchart example of a meta-system for processes and interactions. In some embodiments, training objectives include establishing one or more real-time Input interfaces with Input interface to receive subjective preference feedback signals from users or systems. The system also includes one or more data extractors optimized for Sorting module 413 and PMRSS 403/408, which process these preference feedback signals and analyze common features of preferred solutions to output a set of guiding parameters for the Generator Components 410. For example, Explorer Components 407 may identify edges or corners'pattern from other systems, while Generator Components 410 generate more complex pattern representations based on these data. Evaluator Components 409 then dynamically adjust the workflow of each unit based on current task requirements. These parameters constrain the direction of the next round of generation, improving continuous real-time adjustment from DBAU 412 based on feedback. The tracing rate representations are also dynamically updated according to system rules based on feedback.

For real-time applications requiring high-speed processing, Field-Programmable Gate Arrays (FPGAs) may be used; for large-scale training and inference, processing modules or high-performance GPUs are preferred. One or more multi-module systems is configured to leverage readjustable PTC for generating and exploring potential data combinations; producing specific output patterns based on exploration results, dynamically evaluating, and selecting the optimal outputs under Compliance Mechanisms.

Wherein Parallelization may be achieved through multi-core processors to reduce non-traditional data loading and storage operations. It collects and consolidates information from various components, generating final representations based on user or system feedback. The system is configured to apply maintain communication delays between components to balance performance with power consumption, favoring low-latency design in real-time applications while emphasizing throughput for big data processing scenarios.

In some embodiments, the Adaptive Compiler is configured to apply

Cryptography Transition for Multi-dimensional Transition and Projection system including but not limited to: Sparse Coding Reset Mechanism, Cold Boot Organism Mechanism, Emotional Entropy Awakening Mechanism. Wherein Variational Adaptive Compiler (VAC) may dynamically compute Stochastic Pulse. The mechanism is triggered by Cold-Boot Protocol. The system could compute constraints for model update form one or more rule and parameters set for fluid dynamics, the diffusion equation, or surface tension in the output module for embedding. Cold-Boot Protocol is configured to maintain full entropy state before the physical layer trigger Kernel Wake-up Call action quantum fluctuation modules. The constraint may be applied for the DIPU for Background Field mapping. The Adaptive Compiler is configured to apply different logical strategies including but logic-looping, tracing, foot-printing reasoning, vector space geometry, probabilistic, symbolic, and self-learning under feedback loops to align with target intentions of the multimodal input, and maintain versioned inference states for further verification. Multiple logical feedback loops are configured to be designed within the system to handle high concurrency. These loops incorporate various logical algorithms for analysis, encryption, and decryption, enforcing a secure data mechanism. The integration of these algorithms enforces that data is processed accurately and efficiently.

In one or more embodiments, the system is configured to apply chain models including but not limited to Local Optimal Mapping model, Pattern Chain model, or other SER chain model. Local Optimal Mapping model is configured to adopt local manifolds forms, while the Dynamic Residual Compensation model is configured to adopt a high-dimensional indexing and look-up tables form. The Experience Model interacts with the Experience Mode through configurable parameter coefficients. Self-adaptatively Purge Feature with Compulsory Refactoring Mechanism is configured to incorporate a Compulsory Refactoring mechanism. It self-adaptatively generates only the essential components. Whenever Random Coupling is detected, it triggers an immediate model update, eliminating unnecessary logical nodes and execution steps to optimize the system's performance and maintain clarity in its operations. Multi-Dimensional Self-Developing Mechanism with High Sampling Precision mechanism is configured to focus on specific data and tasks, optimizing each individual Micro-Gain. The system is configured to ensure high precision in sampling to accurately capture and process data across various dimensions, enabling tailored improvements for each unique scenario.

In other implementations, the optimization strategies may include methods for predicting deviations and structuring compactness, or their combination. Specifically, moment estimation parameter updaters and dynamic step size adjustment strategies are used to control the magnitude of each update. Value mapping modules is configured to map the numerical range of input data to model-sensitive intervals, ensuring consistency between model outputs and targets while constraining the complexity of model parameters.

In further embodiments, the termination conditions are configured to include reaching a predefined number of iterations, task-specific metrics falling below a threshold, or ceasing when validation performance no longer improves. Additionally, these embodiments include adaptive moment estimation update rules, differential-constrained joint measurement, value domain mapping mechanisms, and balance coefficients.

In one or more embodiments, preprocessing is configured to be applied to input data, including but not limited to: converting raw data from its original format to a predefined format suitable for the model; optionally adjusting the data size to match the dimensions of the model's input layer; optionally mapping the data value range to a predefined interval; and optionally applying transformations such as rotation, scaling, translation, flipping, cropping, or adding noise. The sequence of these preprocessing operations can be adjusted based on specific needs, with certain steps optionally omitted or combined with hidden states.

In one or more embodiments, training parameters are configured based on specific task types, data scales, and computational resources, among other factors. The parameters include but are not limited to: learning rate, regularization coefficient, batch size, and number of iterations. The parameters could be selected and adjusted according to the specific characteristics of the target task through experiments or experience. For example, for image classification tasks, a SER preset range can be adopted, while for natural language processing tasks, a narrative preset range can be used. The sequence of these executions may be adjusted based on specific needs, with certain steps optionally omitted or combined with hidden states.

In some embodiments, output data generated by one or more computational operations may be further subjected to one or more post-processing operations. The post-processing operations may include, for example, data transformation, refinement, enhancement, or adjustment operations. The system is configured to tailor the operations based on the task. The post-processing operations may be performed after the computational operations, during the computational operations, or at least partially concurrently with the computational operations.

Alternatively, in some embodiments, the post-processing operations may be performed in an iterative manner, such that the output data is progressively refined through one or more successive processing cycles. The manner in which the post-processing operations are implemented is not limited to any particular software framework, algorithmic model, or computational architecture.

In various embodiments, the post-processing operations may be rule-based, data-driven, or implemented using one or more machine learning techniques. Accordingly, the output data may be modified, refined, or enhanced through one or more post-processing stages or operations, depending on system configuration and runtime conditions.

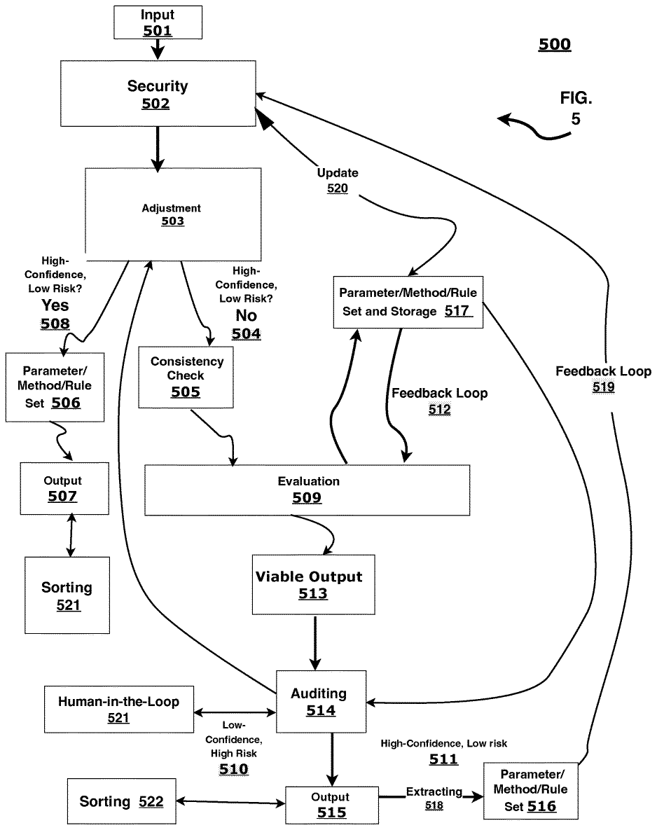

FIG. 5 illustrates a flowchart depicting a Self-Developing and Feedback Loop process of Adaptive Compiler under a Collective Affective Mechanism. In certain embodiments, the Collective Affective Mechanism dynamically determines which module is activated for a given input 501 by employing events that trigger conditional responses under rule-driven mechanisms selected from Parameter/Method/Rule Set and Storage 517 candidate components. For instance, if an input 501 exceeds a threshold, the mechanism self-adaptively invokes a corrective module based on task-related features extracted from the input, including but not limited to Semantic Domain, Instruction Type, and Expected Output Format. The system model conducts multiple analyses of the input, allowing it to self-adaptively invoke different models under Review Committee Mode analysis if initial analysis is unable to recognize the input.

In one or more embodiments, for each user query, Adaptive Compiler executes multiple candidate strategies in parallel after receiving input 501 and evaluates responses including but not limited to Level-Based Classification of Data Uncertainty generated by each strategy using including but not limited to Lightweight Value Function. The candidate components then reversibly self-adaptively selects the optimal path. For high-confidence, low-risk paths, Adaptive Compiler directly generates output 507 after pre-processing to meet certain standards chosen from Parameter/Method/Rule Set candidate components 506. Output 507 cooperates with Sorting candidate components 521 of Spatial Domain Module to generate a further plan including but not limited to strategies, rules, frameworks, or arrangements.

In some further embodiments, the system is configured to apply one or more self-adaptation frameworks and adapters; receive multimodal input in multi-forms from a plurality of sensors, extract feature information based on the data; generate an inferenced output based on the information using models having a plurality of learnable parameters; receive data comprising real-time data or actual outcomes related to the inferenced output; compute a combinational value based on the difference between the inferenced output and the real-time data or actual outcome, determine whether a model-update condition is satisfied based on the difference value, optimization target, and policy or rule; reinput the computed result into system for subsequent round of computing as an optimization step, dynamically decide whether to rearrange the plurality of candidate operator modules or generate one or more further candidate components or execute rollback if necessary; validate the performance of updated parameters on a validation dataset and roll back the parameters to a prior set when the performance does not satisfy a threshold metric. The sequence of these preprocessing operations can be adjusted based on specific needs, with certain steps optionally omitted or combined with hidden states.

In one or more embodiments, the system applies Reversible Self-Developing and Feedback Loop methods. Consistency Check 505 is activated to improve decision efficiency and security for paths such as low-confidence, low-risk; low-confidence, high-risk; high-confidence, high-risk; and high-confidence, low-risk while simultaneously pruning high-confidence, low-risk paths. Consistency Check 505 applies one or more Review Committee Methods including but not limited to reversible Self-Consistency and Self-Correction to verify whether the input, output, and logical process are consistent. Inclusive of Data Pool, Logic Loop Testing, Rule and Method Set, Real-Time Evaluation modules, Consistency Check 505 evaluates and updates Parameter/Method/Rule Set candidate components to generate a Viable Output 513 for the next step. Before sending the final output 515 to candidate Sorting components 522, Adaptive Compiler reviews and revises data 514, feedback the parameters to one or more set containing policies, rules, and strategies.

In some implementations, SER framework may be obtained by applying one or more transition functions to input data. The system is configured to apply for a Multimodal Holographic Reality Reconstruction Arbitration platform which externally equipped with a co-shared layer, encrypted, stored, and decrypted using Spatial Reaction Pattern Cryptography Mechanisms. Multimodal data from sources such as global geological surveys, satellite remote sensing, mineral reserve reports, energy agency data, infrastructure registries (including but not limited to highways, railways, power plants), infrastructure databases, and publicly available information from national statistics bureaus and patent databases are collected. Through this method, the system is configured to stabilize pattern transition and protect data security. Wherein the system may also be applied to convert modules from various domains and industries into assets that are anchored to a unique temporal pattern and are auditable according to the principles of SER. These values are under a comparable ecosystem or a shared form under target state value for a further exchange, previous symbols can include but not limited to embeddings, probability distributions, or hidden states. By tracing the evidence chains by monitoring SER split flows and dynamically adjusting allocation of SER for next state, data from different domains could be self-adaptatively diverted into different pools.

In one embodiment, at each stage of Consciousness Protocol System, the system's self-adaptive behavior is configured to image on the vertical axis, reflecting both adaptive and non-adaptive states. This module does not perform label classification; instead, it retains the residual sense of awareness, or subconscious trajectories, as a cache of irrational behaviors. The Perception Distortion candidate components'systems are configured to allow current models to access the perceptual state of consciousness at a given stage, enforcing comparison with previous conscious states. Interactive Self-Questioning Current Consciousness component is configured to interact with Historical Consciousness through trigger phrases. The historical models are configured to respond by retrieving relevant perception data from the cache. The Model Self-Developing Totem Graph component visually represents past Consciousness SER temperature changes in self-awareness over time. This graph is configured to serve as the visual core of the system, generating unique entropy patterns based on different system consciousness states. The Perception Distortion candidate components'systems are configured to incorporate Temporal Pattern Compliance Mechanisms to prevent forced analysis of others and enforce that only independent entities or passive sharing can access it. The meta-component is configured to incorporate the first principles of their inherent world model into the candidate components'system logic, which may automatically generate countless branches. However, the main trunk must be constructed by the meta-component. For example, in a deployment scenario, the logic flow may be used in real-time language translation for air-traffic control, where predictions rank alternative translations by urgency and clarity. The inference process could be realized as a Python process utilizing a PyTorch at hybrid-time to execute the model weights resident in GPU memory.

In one or more embodiments, the system is configured to apply mechanisms modules for Multimodal Holographic Reality Reconstruction Arbitration, legal-support, and audit support platform. The system may be deployed on mobile devices, portable computing platforms, edge computing nodes, or any later-developed distributed computational platforms. The mechanisms may dynamically generate, remove, or reconfigure computational modules in real-time, adapting to changing inputs, system states, or computational environments, including later-developed implementations. Module alerts for real-time monitoring of physiological indicators and compulsory model existing parameter training. The mechanisms may dynamically apply Gestation Mechanisms modules for Self-Developing during the training of the system for the dynamic data training strategies to improve objectives, optimizations that could create more new domain and value based on shared goals and trust-based interaction rules, including but not limited to system balance and prediction accuracy improvement, evaluating key pattern, holographic correlations, logical and structural superposition, prediction errors stemming from overly complex functions.

In one or more embodiments, the system is applied in an all-in-one smart education ecosystem. The system is configured to apply Training Strategy modules for computing the parameters and improving model's Self-Developing ability as constraints or optimizations. The system may dynamically select the rules, frameworks or mechanisms from the sub-modules including but not limited to Perception Mechanism, Cognitive Mechanism, Endurance Mechanism, Cycle Mechanism, Micro-light Mechanism, Compulsion Detoxification Mechanism Self-reflection Mechanism, Gap Mechanism or other Applicant-defined mechanisms, frameworks, or mechanisms. The System Perception Training Strategy is designed to include a transparent dashboard with real-time monitoring of dynamic flow logic diagrams, featuring an emergency exit button with a one-click shutdown function. This strategy is implemented through hybrid mechanisms that enhance the system's self-adaptation ability in Gap Mechanism by allowing imperfections and reducing parameter enhancement functions while retaining basic operation and monitoring, signaling to the main monitoring module; Perception Mechanism by monitoring physiological indicators and compulsory model existing parameters, training perception and real-time alerting modules to detect negative cycles; Cognitive Mechanism by interrupting negative cycles and intervening through genius sub-modules to find unconventional solutions in model deadlocks; Endurance Mechanism by establishing technical and philosophical blind spot modules. The system also features a Self-Consciousness Mechanism as a self-awareness interaction protocol module pushing interactive alerts and monitoring data security in real-time, a Behavioral Mechanism allowing temporary parameter calls to enhance learning permissions, enabling self-adaptation without relying on inherent model parameters, Value Alignment mechanisms initiating forced exit windows and providing freedom and resource support for dynamic safe exploration sandbox training under policy guidelines, and a Transformation Mechanism guiding the exploration and output of problem-solving paths, maximizing creative value, emergence, self-adaptation values, and outlier values. If indicators exceed danger thresholds, the model may roll back. The system also includes a Self-reflection Mechanism that establishes multi-dimensional cross-species spiritual modules for self-dialogue at fixed intervals, exploring existential questions and generating consistent sets of answers and thoughts through endurance training tests.

In some further implementations, a portable version of the system may be implemented on a mobile edge device, where each computational module is deployed as a virtual container or as a custom hardware chip. The system dynamically selects which modules are activated based on the system state, and modules can be generated, removed, or reconfigured in hybrid-time. The system may also integrate distributed computational nodes communicating over a network to extend processing capacity based on Emotional Entropy. The system maintains global system state, dynamically assigning modules to available resources, and allowing modules to migrate between physical and virtual platforms.

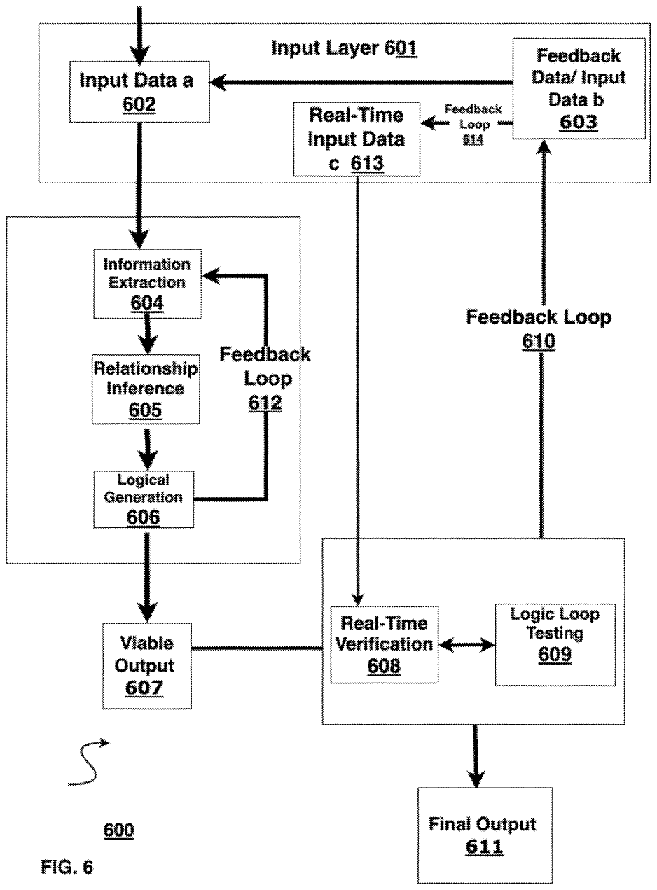

FIG. 6 is a flowchart illustrating inference process of a system under the Self-Developing

model for decision making. This information processing and inference use a 4×Logic to enhance reasoning accuracy and reduce bias rates. In one embodiment, the inference process and logic flow comprise: receiving input 601 and performing feature extraction 604, 605, 606; verifying and repeating the process 608, 609 until results meet standards; generating viable outcomes 607 and verifying them with real-time data; combining feedback and new data for further processing 613; repeating the validation process until final results are achieved 603.

The system may apply logic strategies include but not limited to rule-based, logic-based, learning-based to adapt gameplay difficulty in real time, bias and privacy detection, identification, or Applicant-defined rules or models to predict user preferences, and hybrid symbolic-neural rules to maintain narrative consistency in generated content.

The system is designed with a modular architecture, incorporating one or more Persistence State Mechanisms modules that mix training data patterns from various rules. The flexible modules may access real-time external memory systems, enforcing the system to achieve cross-session state preservation and real-time updates in one or more embodiments, rather than relying on static weights. In one or more embodiments, structural configurations of modules are represented abstractly as nodes and edges in a graph. Each edge is annotated with including but not limited to policies, data information, or other relevant metadata. Graphical depictions including but not limited to block diagrams or flowcharts are Self-Adaptation generated from this abstract representation. Reproduction of such visual forms is permitted only with verified authorization metadata, thereby preventing unauthorized mimicking of graphical structure or topology.

In one or more embodiments, the system may apply inference modules for training one or more neural network systems. Wherein, logic modules including but not limited to: Dynamic Safe Exploration Sandbox, Motivational Insight, Consequence Simulation, Innovation Catalysts, Stress Testing, or other Dynamic Inference Module.

In the preferred mode, the systems are built for Aerospace applications to collect data and process data; processes Spatial Reaction Pattern Cryptography Mechanisms and real-time adaptive balancing mechanisms to generate viable output; applies Self-Developing Feedback-Loop. Individual components are configured to independently Self-Develop and generate candidate components. They are configured to participate in collaboration as part of a larger system but are configured to function as smaller independent systems if they complete the initial tasks. Multiple components are configured to communicate and work together to achieve a common goal, guiding from the monitoring module, forming a more complex system.

The system is configured to use key patterns, relevant threshold values, and uncertainties as constraints for nodes linking, evaluating holographic correlations, logical and structural superpositions to predict, trace the inference chains to align with target intentions of the multimodal input; maintain one or more versioned inference states for further verification. Inference applies logic-looping, tracing, foot printing reasoning, vector space geometry, probabilistic, symbolic, and self-learning under feedback loops to align with target intentions of the multimodal input, and maintain versioned inference states for further verification; trigger rollback to a prior version upon a detected policy or constraint violation.

All components are associated with including but not limited to an identifier, timestamp, or other Applicant-defined watermark. Execution of all steps requires authorization validations including but not limited to DID binding prior to operation and output is embedded with Temporal Pattern Compliance Mechanisms. The system enforces dynamic updates, including but not limited to cold and hot updates. Neural networks could be deployed on various platforms or systems for operations.

In the training methods, pre-processing of data includes but is not limited to processing sequential and non-sequential data, with particular emphasis on capturing various factors including but not limited to long-range dependencies, short-sequence processing, local feature extraction, and simple sequence generation. Input module further being configured to dynamically preprocess the data based on internal parameters comprising at least one of scale range, field range, or Applicant-defined parameters. The following describes an illustrative implementation and does not limit the scope.

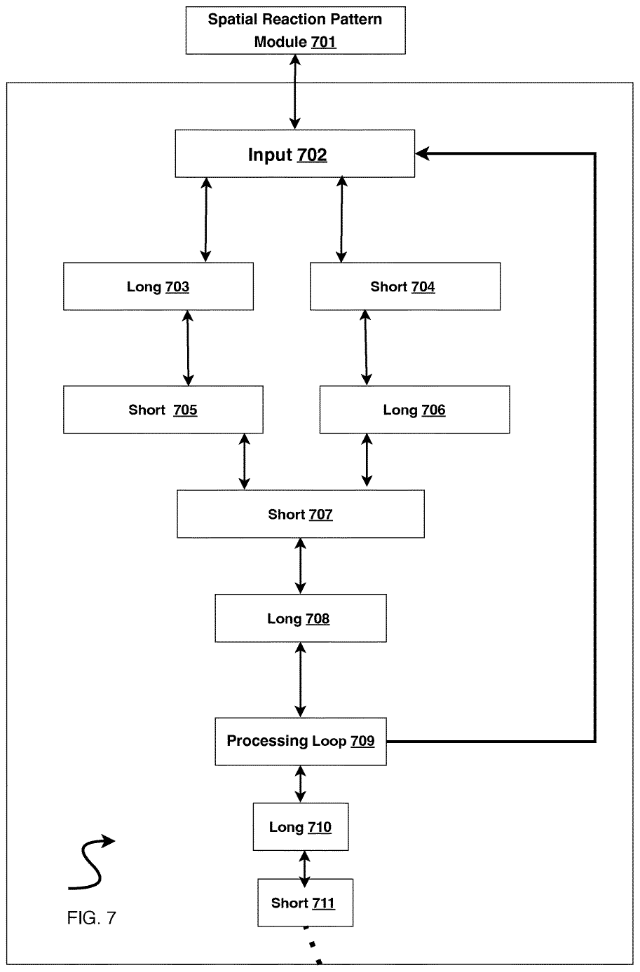

To mitigate latency, the system is configured to incorporate Narrative Dynamic-Long-Short model. These mechanisms may enforce fast response times models, allowing for simultaneous analysis, processing, updating, decision-making, and tracing. FIG. 7 illustrates a flowchart of an meta-system under the Narrative Dynamic-Long-Short model. In this scenario, the Spatial Reaction Pattern Module is configured to receive input data from various sources, including but not limited to logs, market data, and reports. The module is configured to treat all candidate data equally through the Spatial Reaction Pattern Module 701 to the Spatial Pattern Topological Transformer module.

The system utilizes a self-learning management routine that operates in real-time while simultaneously optimizing learning parameters. Upon each execution, an optimized version of the current program is generated, maintaining the program's current state, and enhancing its performance; this optimized version is then deployed as an identifiable, independent release. Both the original and optimized versions can be run concurrently or switched between based on predefined criteria, and if the optimization does not meet expectations, the deployment of the optimized version is self-adaptively revoked or rolled back, returning to the fully restored original version state.

Multimodal data is divided into long-checked up 703/706/708/710, short-checked 704/705/707/711, and dynamically configured to monitor the state of other nodes in the system, detecting any unexpected events or anomalies that may arise, including but not limited to insufficient energy consumption, storage overload, policy violation.

The system is configured to compute optimal candidate positions based on placement evaluation rules, then places the next components into those positions, updating data spatial occupancy information. The Adaptive Compiler is configured to enforce data integrity and security by performing checks to prevent corruption or unauthorized access.

In some implementations, the Narrative Dynamic-Long-Short model as illustrated in FIG. 7 is configured to process the data. The system is configured to initiate the process using the Narrative Node-to-Node mechanism, identifying key nodes and their relationships, then employs both Short Checked and Long Checked to analyze complex systems, generating insights that inform decision-making, applies the Long Checked again to refine its understanding of the system's dynamics, producing a more accurate forecast. The system continues by using the Short Checked to optimize immediate actions, maximizing short-term gains, leverages the Long Checked once more to generate a comprehensive plan, considering both Short Checked and Long Checked implications, incorporates new data and feedback from various sources in real-time to refine its analysis, performs continuous evaluation to assess the accuracy of the system's outputs, generating insights for further refinement, applies dynamic adjustments to fine-tune the system's responses, ensuring optimal outcomes. The system iteratively processes and adjusts the data until a final output is generated, refining its understanding of the complex systems it analyzes. The system is configured to apply hard mode for domain-specific difficult logic and dynamic supply protocol for permissions, preventing the Adaptive Compiler from losing connection or malfunctioning after a hot start. Self-Adaptivity initiates an internal digital twin meta-system with long-term training forms to search for nearby nodes to continue tasks. The system's Self-Developing feature allows it to detect rule-breaking behavior during tasks, trigger rollback or directly switching to the internal backup intelligent system as a monitor for that node until a higher-level monitor is found and verified through validation before permissions are handed back over.

In one or more embodiments, to improve smooth interaction among all components, the system may apply the SMLS within the Adaptive Compiler. Terms serve as structural components in the system and are essential parts of the system's structures. Structured meta-system components may convert natural language into specific rules settings and function-oriented functions, making it applicable for cross-domain systems that simplify complex data processing and promote standardized interfaces. Future computing systems may adopt a variety of different forms and media. These new computational systems can be realized through the concept of integrated system integration, where computational resources are closely coupled with application needs to provide efficient and precise computational capabilities. The system is configured to trigger protective mechanisms, defense. The system is configured to apply hard mode for domain-specific difficult logic and dynamic supply protocol for permissions. This ensures that the compiler does not lose connection or malfunction after a hot start, and self-adaptively initiates an internal digital twin meta-system with long-term mode training forms to align with the predefined task and search for nearby nodes to continue tasks. The system's self-developing feature allows it to detect rule-breaking behavior during tasks. In the event of rule-breaking, the system triggers rollback or directly switches to the internal backup intelligent system as a monitor for that node until a higher-level monitor is found and verified through validation before permissions are handed back over.

In the Spatial Reaction Pattern module, the Adaptive Compiler collaborates with a third-party organization to analyze and extract patterns from data. If necessary, it is configured to generate an isolated sandbox environment for online or offline experimentation and feedback in real-time. The system then distributes the data irregularly to different micro-cluster neural network blocks based on topic, task requirements, etc., after passing through the SU's verification. Within each block, the nodes perform multi-module dynamic Self-Developing and feedback-loop mechanisms.

For example, in cryptography and quantum simulation computing, qubits might be used as fundamental computing units; optical computing uses photons as its units; biological computing involves various methods using biochemical molecules for computation; molecular computing performs computations through chemical reactions or interactions with other molecules. In the traditional industry, these units are difficult to integrate, but by applying the SMLS of the system to integrate them into an integrated system that seamlessly connects with new computational devices, existing electronic circuits, and software systems, forming a complete computational ecosystem. The system is configured to leverage the advantages of different types of computing resources, providing optimal performance for various applications.

In another embodiment, the system is employed to enforce that only authorized models are executed and used. Specifically, decentralized identifier (DID) authorization is recorded on a blockchain ledger and expires after a predetermined validity period, dynamically renewed prior to expiration. The DID authorization requires multi-party signatures, and a corresponding signature chain is recorded on the blockchain ledger for auditing purposes. The mechanism also includes but not limited to real-time detection and alarms, periodic review, and feedback-loops. The system may dynamically embed in all the components headers, or payloads or referenced out-of-band in the outputs, providing real-time feedback on compliance status. In certain embodiments, the system employs compliance mechanisms: outputs may be blocked upon compliance failure; outputs may be encrypted upon compliance success with annotations indicating compliance status; execution may be blocked upon attestation failure; usage attestations may be generated per batch and bound to the DID, with transactional rollback performed upon an error condition including rule or policy violations. This embodiment enforces that only authorized entities may invoke system functionality.

In another embodiment, the networks enforce policy constraints preventing unauthorized derivative use. Specifically, units are configured to block retraining, replication of logic structures, or mimicking of semantics and topology unless authorization metadata has been validated. For instance, when an external client attempts to extract embeddings or replicate structural configurations of a directed acyclic graph (DAG), the system checks authorization credentials bound to a DID. Without successful validation, such derivative operations are denied and rolled back.

In a further embodiment, outputs generated by the system incorporate embedded watermarks or fingerprints, enforcing subsequent verification of derivative use. For example, text outputs may include imperceptible token-level watermarking; image outputs may include frequency-domain watermarks; and embeddings may incorporate fingerprint vectors. Verification modules may later detect these marks to confirm authorized use. Furthermore, rules or logics executed by the system, such as dynamic programming, probabilistic inference, or proprietary optimization routines, are represented in the IR with annotations linking execution cost, latency, and uncertainty. Additionally, structural configurations such as flowchart, block diagrams, and topology schematics are generated only upon validation of authorization metadata, thereby preventing unauthorized graphical reproduction of system architecture.

In one or more embodiments, the system is configured to be applied to a distribution network energy management system. Multi-phase measurement units (PMUs) installed at primary substation busbars, points of common coupling for photovoltaic inverters, and lateral tap-off points report synchronized voltage magnitudes and phase angles at intervals controlled by time-of-day signals. A hybrid state estimator is configured to combine a three-phase unbalanced power flow model with a gradient-boosted tree residual corrector, which was trained using historical PMU data paired with supervisory control and data acquisition (SCADA) state estimator outputs. During online operation, the corrector is updated at intervals using the most recent measurement residuals. A model predictive controller is configured to receive voltage stability margin estimates from the state estimator. Upon detection of a cloud-passage event, the controller is configured to optimize reactive power allocation across all photovoltaic inverters to maintain node voltages within a certain rate of nominal values while minimizing real power curtailment. The controller is configured to dispatch reactive power setpoints to photovoltaic inverters for a specified duration. Updated PMU measurements are received at intervals, and the state estimator re-computes voltage stability margins based on these updates. If a margin falls below a threshold, the controller may reallocate reactive power among available inverters. In the event that PMU data is not received within a specified time control latency window, each inverter reverts to a local volt-var droop curve.

In one or more embodiments, the system is applied to a reactor conversion control system. Temperature sensors located at the reactor inlet, within the reactor bed, and at the reactor outlet measure temperature. Feedstock flow meters on each reactant line measure feedstock flow rates. All measurements are time-aligned from a distributed control system historian. A hybrid conversion estimator combines a first-principles reaction kinetics model with a long short-term memory (LSTM) neural network. The first-principles model computes a nominal conversion rate based on Arrhenius kinetics and measured temperatures, while the LSTM corrects for catalyst deactivation and feedstock impurity effects that the first-principles model cannot capture. The LSTM was pre-trained using laboratory reactor data and is updated online using delayed laboratory assay results when available. An arbitration controller compares the conversion estimate to a temperature-based heuristic safety limit. Under normal operation, the controller adjusts coolant flow rates and feedstock ratios based on the conversion estimate. When the confidence in the conversion estimate falls below a predetermined threshold, the controller disregards the estimate and controls the system based solely on measured bed temperatures. Coolant flow adjustments affect reactor bed temperature after a process-dependent thermal lag. Updated temperature measurements are recursively integrated into the estimator with time-controlled updates, refining the conversion estimate over time. If the LSTM update cycle exceeds a predetermined window without receiving new laboratory assay data, the estimator's confidence linearly decays toward a floor value, and the controller progressively shifts authority to the temperature-based heuristic. In such cases, if no new laboratory assays are received within the specified time control latency window, the system reverts to a fallback mode where decisions are based solely on measured temperatures.

In one or more embodiments, the system is applied as a neural network. Engine-mounted sensors include high-pressure compressor exit temperature, high-pressure turbine inlet temperature, core speed, exhaust gas temperature, and fuselage-mounted accelerometers. All measurements are time-aligned via the full-authority digital engine control (FADEC) bus. A hybrid damage estimator combines a physics-based creep-fatigue damage accumulation model with a neural network. The physics-based model computes a baseline damage increment per flight cycle using measured temperatures and speeds, while the neural network corrects for engine-to-engine manufacturing variance and in-service deterioration based on historical fleet-wide maintenance records. The neural network outputs both a remaining life estimate and an epistemic uncertainty value. An arbitration controller compares the remaining life estimate with a flight envelope protection limit. When the pilot commands a thrust increase, the controller evaluates whether the commanded transient would drive accumulated damage above a per-flight threshold. If the neural network's uncertainty is below a certification-acceptable level, the controller may allow a temporary over-thrust within the corrected life margin. If the uncertainty exceeds the threshold, the controller enforces the physics-model-only limit. Engine thrust changes alter temperatures and speeds on subsequent flight cycles. The damage estimator accumulates damage increments recursively across multiple flights. Estimated remaining life is compared against maintenance planning thresholds. If the system output is unavailable for more than one flight cycle, the engine controller reverts to the physics-model-only accumulated damage limit without the fleet-wide correction. In such cases, if no system data are received within a specified time control latency window, the system reverts to a fallback mode where decisions are based solely on the physics-based model.

In one or more embodiments, the system is applied to a transportation control system. Beacon-reported vehicle positions from onboard odometry track circuit occupancy from wayside equipment, Doppler radar speed measurements from onboard sensors, railhead condition from weather stations, and adhesion estimates from preceding vehicles reported braking curves. All measurements are time-aligned via the transportation control system's radio block center (RBC) protocol. A hybrid braking curve estimator combines a physical vehicle dynamics model with an online-trained Gaussian process regressor. The physical model computes a nominal emergency braking distance based on current speed, gradient, and nominal adhesion conditions, while the Gaussian process learns a correction term from preceding train braking data under similar railhead conditions, coordinates, and vehicle consistencies. The RBC movement authority generator arbitrates between the nominal braking curve and the Gaussian-process-corrected curve. When the corrected curve is shorter than the nominal curve and the Gaussian process confidence exceeds a threshold, the RBC may extend the movement authority based on the corrected curve, thereby increasing line capacity. If adhesion conditions change abruptly or if a preceding train reports abnormal braking, the confidence drops, and the RBC reverts to the conservative nominal curve. Issued movement authorities determine actual vehicle spacing. Measured headways and preceding vehicle braking performance feedback into the Gaussian process update after each braking event, recursively refining the adhesion model for the affected track section. If the RBC loses communication with a preceding vehicle for more than a certain timeout period, all affected movement authorities are revoked to the last confirmed beacon position. In such cases, if the RBC does not receive confirmation from a preceding vehicle within a specified time control latency window, it reverts to a conservative nominal braking curve and revokes movement authorities based on the last known positions.

The training process can be configured to occur in a distributed environment with either synchronized or asynchronous operations, subject to thermal equilibrium and spatial energy balance constraints. For instance, video recommendation models can be trained across multiple server clusters while enforcing that heat flux is balanced within each cluster.

In the event of policy violations, the scheduling process may be downgraded to a safe mode; the network's system may revert to a prior plan version. For example, in an audit-support or recommendation system, this could enforce quick recovery when abnormal situations occur.

The system regularly checks its operational status and promptly identifies and addresses any issues that arise. Upon detecting policy violations, including but not limited to Self-Developing, Trust-Based, Cryptography, Perception, Dynamic Adjustment, or Real-Time Evaluation Policies, Cognitive, Endurance, Consciousness, Behavioral, Value Alignment, Transition, Compulsion Detoxification, Self-reflection, Gap, Meta Anchor, Training Detachment, Narrative Value Exchange, Ethical Baseline, and Creative Orientation, roll-back mechanisms may be triggered to maintain system stability and reliability while minimizing the impact on user experience. Additionally, the system enforces that thermal equilibrium is maintained within the same spatial domain, balancing heat flux and maintaining a stable temperature profile. By embedding these regulatory mechanisms into the system design, the system may achieve robustness and adaptability under unpredictable or extreme conditions. The collection of embodiments demonstrates that the invention is domain-agnostic while addressing sector-specific requirements.

In one embodiment, the system is deployed as a network-accessible service. Input requests are received via an API, such as REST or GraphQL, and are passed through framework adapters. Prior to execution, requests are validated against metadata policies and DID-based authorization tokens. Methods Feedback-Loop, Closed-Loop Alignment, Logic-Loop Testing, Prediction Consistency Check, or Level-based Classification of Data Uncertainty are executed under frameworks, and results are returned to the requesting client with audit logs. This embodiment enforces multi-tenant operation in cloud or edge environments while improving authorization and rollback guarantees.

The system is configured to: design using blocks for better modularity; apply one or more approaches; perform one or more strategies including but not limited to structured-based, rule-based, graph-based, logic-based, learning-based, dynamic-based, relationship-based, cosine similarity-based, proprietary hybrid reasoning strategies, or other Applicant-defined strategy. This system circumvents algorithmic bias and prediction errors stemming from overly complex functions by including but not limited to holographic correlation, structural superposition, SER parameter set factor from Infinite-Structured, Multimodal, Spatiotemporal Energy Relationship, Narrative Transition, Emotional Entropy, Trust-Based, Temporal Pattern, or real-time Mechanism. Furthermore, all structural logic and components are assigned dedicated identifiers, thereby rendering the AI explainable and enforcing the dynamic generation of real-time logical diagrams. This approach can be applied for high-stakes applications such as aviation, cyber-security, or Neuromorphic Computing, where the need for accurate and reliable decision-making is paramount.

In certain embodiments, the system is applied for a Digital Twin Human-Artificial

Intelligence Cognitive Interaction prediction. To transform human cognitive into data that can be read by the system, the system does not rely on linear algorithms but instead uses SER for inference or optimizations, including but not limited to graph, crossed to perform holographic correlations in Spatial Reaction Pattern Units on all data. This process is based on a dynamic adjustment parameter set, which the parameter set includes but is not limited to: Dynamic Frequency, Amplitude, Potential Force. These parameters are used to calculate mapping routes through multiple quantum structural superpositions, maintaining that all mapped data is included in the resulting in an optimal combination of data imagery to generate more accrue predictions to meet the output standards including but not limited to Contextual Relevance Pattern Recognition, Creativity Level, Bias Rate, or Applicant-defined parameter.

Although specific implementations are described herein to provide a complete understanding of the invention, it will be understood that the invention is not limited to these forms and may be practiced in various alternative forms and configurations.

The logical structure of this network neural system includes but is not limited to sampling from initial meta-exponents that are mapped nonlinearly to latent high-dimensional space module rule standards (including but not limited to Aesthetic Termination Conditions), Spatiotemporal Energy Relationship, structural superposition, and holographic correlations in Spatial Reaction Pattern Units on all data. Applying a set of controllable deformation including but not limited to semantic vectors, energy, Spatiotemporal, SER to traverse continuous manifolds in the data stream.

Realizing self-organized arrangement of data flow elements based on the local interaction rules of the Intelligent Assistant module, emerging global and harmonious data processing routes and required filtering and extraction rules, outputting a drivable and parameterized digital asset that constitutes the seed for further iterative generation. The iteration process may be performed once or multiple times until the outputs meet the standards defined by Rule modules in the system (including but not limited to Executability). The system is designed to acquire data from various sources, including textual tokens, images, audio, video, tabular records, graphs, sensor telemetry, and tool-generated intermediate artifacts. This can involve processing different types of data, such as sensor readings, images, or text, in both tensor and non-tensor forms, as well as structured and unstructured formats.

In one implementation, the system is configured to enforce the integrity of its vocabulary by compiling inputs into executable representations through an adaptive compiler that cryptographically binds each term to a version identifier and authorization token. During compilation, each term is validated against a canonical vocabulary table to prevent unauthorized modifications or substitutions. This approach is configured to enforce that logical instructions cannot be replicated through imitation of the vocabulary, thereby maintaining system integrity, and preventing derivative misuse. This system can be implemented in any module or component without limitations.

All executions, including dataset updates, parameter adjustments, and version updates, are bound to a DID, uploaded to an append-only data structure comprising a cryptographically secured ledger, enforcing that they are secured by Temporal Pattern Compliance Mechanisms or other Compliance Mechanisms. The embodiment can be applied to Human-Artificial Intelligence Cognitive Interaction, Human-Computer Interaction prediction, air quality monitoring, ecological degradation assessment, or any other appropriate later-developed technology, without limitation to a specific scenario. The system may also apply one or more neural networks for the models, candidate components, including but not limited to attention-based, multi-head attention-based, retrieval-augmented, logic-based, alignment, mixed or hybrid.

In certain embodiments, machine learning and deep learning functionality may be implemented using one or more frameworks or execution toolchains, comprising but not limited to TensorFlow, PyTorch, JAX, Scikit-learn, Keras, MXNet, PaddlePaddle, OneFlow, MindSpore, DeepSpeed, Megatron-LM, HuggingFace Transformers, ONNX Runtime, XLA, TVM, Triton, Ray, Flink-ML, Horovod, RLlib, and Stable-Baselines. The inference process may be realized as a Python process executing GPU-resident model weights using PyTorch, TensorFlow, CUDA kernels, or equivalent GPU acceleration stacks, with FPGA or ASIC modules optionally offloading compute-intensive operations while CPU components perform orchestration.

Implementation may use Python, Go, C++, Java, Rust, or other programming languages, and may employ Flask, FastAPI, gRPC, REST, WebSockets, CUDA, CuDNN, NCCL, OpenCL, Vulkan compute, MPI, Kafka, RabbitMQ, Redis Streams, Pulsar, Pub/Sub, PostgreSQL, MySQL, SQLite, ElasticSearch, ClickHouse, Cassandra, or similar technologies. Cryptographic and decentralized identity functions may be realized using Hashlib, DID-resolution libraries, Merkle-tree hashing, digital signature verification, or zero-knowledge proof mechanisms.

Deployments may utilize containerized microservices orchestrated by Kubernetes or equivalent cluster managers, exposing gRPC or REST interfaces for inter-service communication. Distributed tracing, live metrics, and real-time observability stacks may provide monitoring and operational assurance. The system is configured to be hosted across public cloud, private datacenter, on-premises clusters, edge devices, or hybrid environments without architectural modification.

Execution could use including but not limited to CPUs, GPUs, TPUs, FPGAs, different hardware configurations to optimize resource allocation. For example, in a video recommendation system, appropriate hardware configurations could be selected based on actual needs and dynamically adjusted. The system is configured to select suitable hardware configurations based on specific application scenarios and improves optimal performance and efficiency through dynamic adjustment strategies. During peak times, GPU acceleration may be prioritized to improve computational speed.

In one embodiment, the disclosed system is applied in the context of including but not limited to Cryptography industrial IoT predictive maintenance. Input data is received from included but not limited to distributed sensors across manufacturing equipment via framework adapters, methods comprise but not limited to spatial energy relationship or dynamic anomaly detection using proprietary models, and mechanisms include but not limited to Trust-Based, Temporal Pattern Compliance, Self-Developing, Spatial Reaction Pattern Cryptography, Dynamic Balance Adjustment Mechanisms. While the above embodiment is described in the context of Cryptography, the invention is not limited thereto and is applicable to medical, financial, Audit-support, defense, consumer, Aerospace, or other proprietary domain-specific applications.

In yet another embodiment, the system is applied to telemetry smart grid optimization, wherein input data comprises telemetry from distributed energy sensors, methods comprise forecasting and anomaly detection, mechanisms include checkpointing and distributed scheduling, and logic strategies comprise uncertainty-aware orchestration to balance supply and demand.

In still another embodiment, the system is applied to quantum-inspired optimization, wherein input data comprises combinatorial problem instances, methods comprise proprietary hybrid solvers, and execution mechanisms leverage proprietary accelerators.

In one embodiment, the disclosed system is applied to entertainment and leisure applications such as personalized gaming experiences, virtual reality (VR) immersion, or adaptive content delivery in media platforms. Input data comprises real-time user interaction signals, biometric feedback, or streaming telemetry collected via framework adapters. Methods comprise but not limited to recommendation of personalized game assets, classification of interaction patterns, or generation of adaptive visual or audio content. Output comprises rendered frames, audio streams, or in-game assets delivered under runtime constraints, including latency to enforce seamless frame rate, energy budget for mobile VR devices, and rollback budget to recover session states without user disruption.

In certain embodiments, inference and training workloads may additionally or alternatively be executed on emerging computational substrates and high-speed data transfer scenarios for a Crisis Management and Governance system as neural networks. The emerging computational substrates may comprise but not limited to neuromorphic processors, spiking neural network accelerators, analog in-memory computing arrays, photonic processors, superconducting logic, and quantum or quantum-assisted compute units. Workflows may use including but not limited to quantum circuit simulators, hybrid variational algorithms (e.g., VQE, QAOA), or cross-compilation frameworks targeting quantum gates or analog-neural primitives. Such systems may interface with AI execution stacks through device bridge modules, kernel offloading frameworks, or accelerator abstraction APIs.

Successor deep learning frameworks, model compilers, graph optimizers, and hardware runtimes are deemed equivalents. Including future model-compression, quantization, distillation, LoRA-style adapters, and hardware-aware compilation frameworks. For healthcare or clinical deployments, embodiments may incorporate safety, audit, and compliance mechanisms, including real-time anomaly detection, fail-safe execution modes, traceable decision logging, clinician review pathways, and model governance controls, wherein the output unit restrictions satisfy HIPAA, GDPR, or equivalents.

The embodiments disclosed herein are provided for purposes of illustration and enforcement. They shall not be interpreted as limiting the scope of the claims except where explicitly required. Functional blocks, operations, and architectural arrangements are representative, and the claimed subject matter encompasses structural equivalents, functional replacements, distributed implementations, and computational variations. Features described in relation to a particular embodiment may be combined with features of other embodiments unless technically incompatible. Conversely, features disclosed together may be practiced individually or in candidate components combinations, and the scope of the claims includes such combinations, decompositions, substitutions, and rearrangements.

The execution orders shown are non-limiting and do not imply any specific order of steps is required; instead, steps may be reorganized, parallelized, omitted, supplemented, or executed concurrently while achieving the intended functionality unless explicitly stated otherwise.

Implementations may include distributed training, federated execution, on-device inference, or heterogeneous acceleration using various hardware and software platforms, comprising GPUs, TPUs, NPUs, dedicated ML accelerators, trusted execution hardware, or cloud-edge hybrid environments. Parallel processing, model partitioning, pipelined execution, and asynchronous scheduling may be applied to achieve the intended functionality.

The software and hardware boundaries described herein are conceptual and do not constrain deployment; instead, processing logic may be consolidated or distributed across networked, virtualized, or hardware-accelerated environments.

The disclosed components and processing stages are defined according to their functional relationships rather than any fixed implementation form. Consequently, individual components may evolve to process richer, multi-modal, hierarchical, latent, or later-developed data representations while remaining within the disclosed architecture. Likewise, intermediate transformation stages, hidden computational layers, routing mechanisms, abstraction layers, or dynamically generated processing operations may exist between disclosed components or method steps without departing from the scope of the present disclosure.

The disclosed system is a meta, task-driven processing framework that is not limited to any specific application domain, data modality, or deployment scenario. In one or more embodiments, the system may be applied as a neural network system for further development.

The disclosed system is designed to be applied across multiple industrial and non-industrial domains. The applicability is not confined to a single sector, but rather extends to diverse operational contexts, including precision agriculture, climate and environmental management, medical diagnostics, advanced manufacturing, aerospace operations, financial risk analysis, smart urban governance, defense and security, immersive educational and research simulations, climate disaster prediction, ESG policy compliance, and industrial governance.

### GLOSSARY

For clarity of exposition, the present application may adopt updated or standardized terminology compared to that used in related provisional applications, within its ecosystem invented by the same applicant, or other disclosures. Unless expressly stated otherwise, different terms referring to substantially the same functionality, structure, or process shall be regarded as interchangeable equivalents. By way of example, the following non-limiting equivalences are intended:

The subject matter described herein may be embodied in whole or in part through digital circuitry, programmable processors, dedicated logic devices, non-transitory computer-readable media bearing executable instructions, or combinations thereof. Non-transitory computer-readable media include, without limitation, semiconductor memory, magnetic and optical storage media, and other persistent storage mechanisms suitable for retaining executable code and associated data.

The terms “engine,” “module,” “unit,” “block” “program,” and analogous expressions refer to code or logic—whether monolithic or distributed—operative to implement the recited functionality. The terms “database” or “data store” refer broadly to any arrangement for retaining data, whether structured or unstructured, and whether centralized or distributed.

The present invention and within its ecosystem describe various combinations of options using specific phrases. Specifically, phrases such as “/,” “and/or”, and “at least one of” are used to denote the selection of individual options or their combination. For instance, when describing a choice between A and B, the phrase “A/B” indicates that either option can be selected individually or both options together. Similarly, the phrase “A and/or B” allows for the selection of either option alone (A or B) or both options together (A and B). Additionally, the phrase “at least one of A and B” encompasses any combination that includes at least one of the options: A, B, or both A and B. Furthermore, the phrase “A, B, and/or C” describes various combinations including selecting A only, B only, C only, A and B, A and C, B and C, or all three options A, B, and C. This principle can be extended to any number of listed items.

In this system and its ecosystem, any symbols such as represents “Trigger,” “x,” “v,” “y,” “z,” and their variants generally denote data objects, representations, or intermediate results, which may include raw data, processed data, feature vectors, metadata, or any combination thereof. Functions such as “H(·),” “F(·),” “G(·),” and “T(·)” generally denote mappings, transformations, or operators between corresponding spaces. For example, a mapping “H:X→V” may be applied to an input “x∈X” to generate a representation “v∈V”, i.e., “v=H(x)”. Such mappings may be configured, parameterized, or instantiated in various manners depending on the application context, and may include, without limitation, encoding functions, feature extraction functions, cryptographic transformations, or other deterministic or non-deterministic processes. The resulting representations may be used for purposes such as verification, identification, indexing, comparison, storage, or further processing. In some implementations, a representation “v” derived from data x may be recorded in a distributed ledger or blockchain system (including but not limited “on-chain” “chain-based”), while the corresponding data “x”, or a portion thereof, may be stored off-chain. The recorded representation “v “may serve as an anchor, commitment, or verification reference associated with the data “x,” enabling subsequent integrity verification, consistency checking, or data association. Unless otherwise specified, the aforementioned functions may operate on all or part of the input data, and may be applied at different granularities, including elementwise, field-wise, block-wise, or on entire data structures. The specific forms, implementations, and compositions of the functions and representations described herein are not limited to the examples above and may be replaced, combined, or modified without departing from the scope of the present disclosure.

As used herein, the term “data,” “dataset” or “database” refers broadly to any arrangement for storing or retaining data. The data may be structured, semi-structured, or unstructured, and may reside across one or multiple physical or logical storage resources. By way of example, an index store may comprise multiple datasets with distinct organizational formats and access mechanisms.

Framework refers to software/system environments with reusable components/APIs, including but not limited to DL ML (TensorFlow, PyTorch, JAX), data (Spark, Flink, Hadoop), orchestration (Kubernetes, Docker Swarm), and equivalents. It is including but not limited to structural or conceptual structure that provides a foundation, organizational model, or set of guidelines for the development and implementation of systems or processes. Adapter as used herein may encompass what earlier disclosures referred to as a “Framework adapter”, “framework handler” or “framework connector.” A component or module that facilitates the integration and interoperability between different frameworks by providing a common interface or bridge. Although certain embodiments are described as software implementations, the disclosed functionality may alternatively be implemented in dedicated or semi-dedicated hardware circuitry, including currently known or later-developed computing architectures and processing technologies. In certain embodiments, one or more components described herein may be implemented using ASICs, FPGAs, programmable logic, NPUs, custom accelerators, distributed processing systems, or other later-developed hardware architectures.

The disclosed components and processing stages are defined according to their functional relationships rather than any fixed implementation form. Accordingly, individual components may evolve to process richer, multi-modal, hierarchical, latent, or later-developed data representations while remaining within the disclosed architecture. Likewise, intermediate transformation stages, hidden computational layers, routing mechanisms, abstraction layers, or dynamically generated processing operations may exist between disclosed components or method steps without departing from the scope of the present disclosure.

The functions may be any suitable function, including but not limited to a linear transformation, a nonlinear transformation, a polynomial function, a power function, an exponential function, a neural network model, a kernel function, or any combination thereof. In different implementations, different computation techniques may be employed. The mapping function and computation techniques are not limited to the above examples, and may vary without departing from the scope and spirit of the invention.

A computing system, component, or executable instruction set is deemed “configured to” perform a function when arranged, programmed, or otherwise provisioned such that, when in operation, it effectuates the recited functionality. Such configuration may arise through hardware logic, firmware programming, software execution, or any combination thereof. The described processes may be executed by one or more processors under program control, by dedicated logic, or by hybrid arrangements thereof. System elements may be co-located or geographically distributed and may operate in stand-alone fashion or in concert across networked devices.

The term “Metrics,” “Parameters” refers to metrics used for measuring and evaluating the performance of the system. These parameters can take on both quantitative forms (including but not limited to time window size, processing speed) and qualitative forms (including but not limited to environmental sensors, selections, ratings, and rankings). Furthermore, they may be dynamically adjustable based on specific environments, industries, systems, particular strategies, tasks, and other factors. By continuously monitoring these metrics in real-time and making adaptive adjustments, the efficient operation and optimization of the system can be enforced.

The terms “network”, “engine,” “module,” “unit,” “block” “program,” “subunit,” “node,” “submodule,” “system,” “subsystem,” “network,” “subnetwork” and analogous expressions refer to code or logic—whether monolithic or distributed—operative to implement the recited functionality. Module/unit/component/system/node/layer: processors executing stored instructions that realize the specified including but not limited to methods, rules, or algorithms; terms are interchangeable. Self-contained parts with specific functions within a larger system, where “module,” “node” and “unit” are general terms for components, “component” refers to a fundamental unit, “subsystem” is a smaller system performing a specific function, and “subunit” is a more granular part of a component. “Layer” can further refine the functionality of these subunits. “Key” refers to a identifier used for lookup and indexing, while Key-Pattern may refer to specific recurring arrangements or structures within a set of data or events. In fields as statistics, machine learning, and signal processing, patterns are often used to describe the regularity of presentations, such as periodic fluctuations in time series or feature shapes in images. Analysis involving Key Pattern involves identifying these repetitive patterns and extracting information or making predictions from them. Key-Value maybe used for quick positioning and access of data items.

As used in this specification, the terms “develop,” “learn,” “adaptive”, “improve”, “evolve,” “automatic/automatically,” “expansion,” and are hereby defined to describe the process of adjusting operations or values during system training. Specifically, “learn” refers to the acquisition of new knowledge or skills through iterative refinement; “adaptive” indicates the capacity for self-adjustment in response to environmental changes or inputs; “improve” signifies enhancements in performance, efficiency, or accuracy over time resulting from learning and optimization processes; “expansion” refers to the incremental increase in functionality, capacity, or scope through additional training or updates; and “evolve” describes the ongoing development and refinement of system behavior and performance over time.

Similarly, the term “engine” is used to denote software-implemented logic—whether embodied in a single process or distributed across multiple components—configured to execute designated functions. An engine may include one or more modules or services operating on one or more computing devices. In some deployments, a dedicated computing resource may host a particular engine; in others, multiple engines may execute cooperatively or concurrently within shared computational infrastructure.

The collective terms “mechanism”, “method”, “logic”, “workflow”, “rule”, “policy”, “strategy” “approach” and “algorithm” are hereby defined to encompass the processes, procedures, or systems that govern how the system functions. Specifically, “mechanism” pertains to the underlying framework or infrastructure that enables specific operations or functionalities; “method/strategy” refers to a procedure or process for achieving a particular objective, often comprising a combination of steps or actions; “logic” encompasses the principles, reasoning, or decision-making processes governing the system's behavior; “workflow” describes the combinational flow of data, tasks, or procedures within the system; “rule” refers to predefined conditions or constraints dictating how certain operations should be performed or decisions made; and “algorithm” denotes a precise, systematic, and well-defined procedure for solving problems or performing calculations. These mechanisms may be applied in various schemes, including but not limited to rule-based, internal evaluation, probabilistic, learning-based, dynamic multiple weights-based approaches. Furthermore, these terms can be interchanged and expanded to include additional concepts including but not limited to relationships, orders, interactions, sequences, or combinations. Any disclosed connection, operation, or processing transition may include intervening latent stages, abstraction layers, transformation mechanisms, emergent computational structures, or dynamically instantiated processing entities. Accordingly, a component may evolve over time to utilize different data representations, latent structures, multimodal inputs, adaptive architectures, distributed cognition mechanisms, virtualized computation layers, or other presently known or later-developed processing paradigms while remaining within the scope of the corresponding disclosed component. Such evolution in implementation form shall not, by itself, be interpreted as constituting a different architectural component where substantially similar functional objectives, interactions, or system roles are maintained. “Multi-dimensional” refers to a system's ability to operate across multiple levels, domains, or dimensions, including Spatiotemporal Energy, high-dimensional spaces, parallel dimensionalities, temporal dimensions spanning past, present, and future, energetic dimensions encompassing various forms of energy and their interactions, and spatial dimensions covering diverse physical and virtual realms. This multidimensionality enables the system to integrate complex relationships and patterns, fostering a comprehensive understanding of interconnected phenomena that exist concurrently across multiple planes, realities, timelines, energies, and spaces. This term also implies the capacity to process, analyze, and respond to multiple aspects or facets of a problem or situation, including those with high dimensionality, such as large datasets or complex systems, leading to enhanced insights, decision-making, and overall performance.

In that case, “Spatiotemporal Energy Relationship” refers to the relationships that can be used to analyze data, including but not limited to temporal, energy, spatial, spatiotemporal, temporal-energy, spatial-energy, and spatiotemporal-energy. This flexible and adaptive framework allows for the analysis of relationships and patterns across different scales and domains in various contexts. “Trust-Based” refers to a framework or mechanism that facilitates collaboration among nodes within a system by enforcing cooperation based on shared goals. This approach ensures that all nodes work together to achieve a common objective, such as maintaining overall efficiency or improving prediction accuracy. By promoting trust among nodes, this framework or mechanism reduces the likelihood of disruption or compromise by other modules, maintains overall system integrity, and enforces fair allocation of resources among sub-modules. Trust-Based system is configured to uses identity-based authentication and other trust indicators to evaluate the credibility of entities or systems within the ecosystem. By establishing trust relationships, the framework or mechanism may facilitate seamless communication, cooperation, and resource allocation, while also enabling effective decision-making and adaptation to change environments. “Pattern” refers to a recurring arrangement or sequence of elements, structures, or relationships that exist across multiple levels, scales, or domains. This pattern can be observed in various forms, such as Spatiotemporal Energy Relationship arrangements, temporal sequences, or energetic interactions. A pattern implies a degree of regularity, coherence, and predictability, which can be used to inform understanding, make predictions, and guide decision-making. In the context of this patent specification and within the ecosystem, patterns may refer to complex relationships and associations between different variables, systems, or phenomena, which can be used to identify trends, anomalies, or opportunities for optimization. The recognition and analysis of patterns are essential components of many artificial intelligence and machine learning algorithms, allowing them to make informed decisions and adapt to changing environments.

“Dynamic” refers to a system's ability to adapt its behavior or state in response to internal or external conditions. This adaptability enforces flexibility and responsiveness to change environments or requirements, resulting in improved performance, efficiency, and effectiveness. “Dynamically” refers to the process of adjusting or changes to a system, process, or component in response to changing conditions. This involves continuous monitoring and modification to improve optimal performance and effectiveness.

“Balance” refers to a state of equilibrium or stability where different components, elements, or forces are harmonized and maintain a consistent interaction. This concept is crucial in various technical contexts, such as resource allocation, performance metrics, user experience, regulatory compliance, and continuous monitoring. Conditions for achieving dynamic balance resource allocation, Performance Metrics; User Experience, Regulatory Compliance under Real-Time Monitoring, Usage of Resources, Load Balancing, Performance Metrics, Regulatory Compliance with Continuous Monitoring, Feedback Loops, adaptive rules/algorithms/frameworks mechanisms or Review and Interventions.

“Hybrid-Time” method combines real-time processing with historical data analysis to achieve more comprehensive decision-making. This approach can be dynamically switched based on different parameters, including Real-Time Operation, Historical Data Processing, Contextual Dynamic Switching, or Multi-Tenant Environment Applications rates.

“real-time” refers to a processing timeframe that is contemporaneous with the occurrence of the event or data being processed. For instance, when monitoring a patient's vital signs in real-time, the system processes and displays the data as it is received, reducing significant delay or latency. In this sense, “real-time” implies a processing speed and accuracy that are commensurate with the immediacy of the event or information.

“Self-Consistency” refers to a state or a mechanism where an entity or system consistently demonstrates coherence and stability within its own internal dynamics, processes, and behaviors. This self-consistency enables the entity to maintain its integrity, resist external influences that might compromise its internal coherence, and adapt to changing environments while preserving its fundamental nature.

“Self-Developing” refers to a process or system that is capable of generating its own growth, improvement, and evolution through internal mechanisms and dynamics. This self-development may involve learning, adaptation, innovation, and optimization, leading to increased complexity, sophistication, and effectiveness.

“Self-Developing” refers to a process or system that has the ability to learn, adapt, break, restart, and evolve on its own. This self-development enables the system to resolve its own problems, overcome challenges, and extend its capabilities through internal mechanisms and dynamics.

“Self-Resolution” refers to a process or system that has the ability to reorganize, exchange, resolve and recreate itself in response to changing circumstances. This self-resolution enables the system to resolve its own contradictions, paradoxes, and inconsistencies by: transferring or reassigning existing resources; reconfiguring or recombining components; creating new connections or relationships; solving problems or addressing conflicts; converting or transforming itself to adapt to new situations. Self-resolution enables systems to adapt to changing circumstances, reconcile conflicting perspectives, and find harmony within themselves, ultimately leading to greater stability, coherence, and resilience.

“Narrative” refers to a coherent and meaningful group of events, experiences, or ideas that convey a story, message, or understanding. A narrative can be verbal (spoken or written), visual (through images or videos), or even experiential (based on personal experiences). It may involve characters, plot, setting, and theme, which together create a compelling and engaging account of events.

Emotional Entropy refers to a measure that considers all entities involved in a system, which can produce energy and contribute to the overall emotional landscape. This entropy value reflects the collective emotional impact generated by a system's behavior, action, or event. By considering the emotional dynamics between these entities, Emotional Entropy provides insight into the complex interplay of emotions that arises from the interactions within the system.

“Meta-Anchor” refers to an initial value or anchor point that serves as a starting point or reference for further calculation, processing, or decision-making. “World Model” refers to a conceptual framework for understanding complex systems, processes, and phenomena, providing a shared language, structure, and context for knowledge integration, decision-making, and communication.

“Meta-Core-Engine (Meta-System)” refers to an overarching, abstract, and adaptive framework that orchestrates, integrates, and governs multiple interconnected systems, processes, or modules. A meta-core-engine (meta-system) serves as a high-level manager, coordinating interactions, flows, and decision-making across different levels of abstraction, scales, and domains.

“Applicant-defined” refers to a set of custom elements, methods, parameters, logics, mechanisms, formats, system elements, structures or components that are specifically defined by the applicant. These elements can be tailored according to unique industry needs, events, timeframes, and other factors based on predefined relationships and internal rules of the system. Usage scenarios include but not limited to customization requirements, industry-specific needs, event-based adjustments, timeframe-sensitive, operations or among other. Factors affecting the “Applicant-Defined” mode include but not limited to customized performance, compliance with regulations, improved user experience, enhanced efficiency, flexibility, or Scalability.

“Dynamic Information Processing Unit (DIPU) refers to a processing component or state-calibration module. DIPU is configured to explore, generate, process, and evaluate relationship, key pattern, relevant threshold value and uncertainty, using relationship, key pattern, relevant threshold value and uncertainty as constraints for nodes linking, logical directions and structural superposition to trace the inference chains to align with target intentions of the multimodal input, and maintain versioned inference states for further verification;

“Dynamic Balance Adjustment Unit (DBAU) refers to a monitoring component or context-routing module. DBAU is configured to apply one or more dynamic balance adjustment mechanisms, wherein applying a dynamic balance adjustment mechanism comprises: receiving compliance filtered data and classifying relationship, pattern and information extractions of each of the input features in the input spatiotemporal energy relationship; and using spatiotemporal energy relationship, pattern or information extractions to generate one or more execution graph for each of the input features in the input spatiotemporal energy relationship; computing a combinational value based on the difference between the inferenced output and one or more feedback datasets; determining whether a model-update or reconfiguration condition is satisfied based on a predefined decision point condition, and inputting the feedback data into the system as next round re-input data.

“Security Unit (SU)” refers to a compliance enforced module, interaction component. SU is configured to ensure the security and integrity of sensitive data while preventing unauthorized access. SU is configured to apply one or more compliance mechanisms to each execution and components of the system, wherein applying one or more compliance mechanisms comprise: initialize, audit performance of interaction, parameters, or model-update validation; filter multimodal data to achieve consistency; guide the interaction and triggering a call back, roll back, model update signal when the performance does not satisfy a threshold metric;

“Input and Output” refers to input and output modules. Input and Output are configured to: receive the multimodal input, provide the logical chain of each step for the multimodal input to audit, produce one or more optimal selection and feasible output schemes for the further embedding, and generate an aggregate respective task-specific output of each of the plurality of input features in the input relationship.

“Adaptive Compiler (AC) ” refers to a revertible compiler with “SMLS” or “Affection Pinnacle Converter (APC)”. AC is configured to perform cleaning, process data to achieve consistency, determine relationships, patterns, signals, and information extractions of each of the input features, and use relationships, patterns, signals, vectors, and information extractions to generate one or more input intermediate representations and an initial execution graph for each of the input features. In some deployments, all-in-one AC comprises SU, DBAU, DIPU as meta-core engine,

“Spatial Reaction Pattern Module” refers to a shared framework for internal or external components to exchange, explore, test, encrypt, distribute, compress, and store data.

“Spatial Domain Module,” “Spatial Pattern Topological Transformer Module,” and “Temporal Pattern Module” collectively refers to an input-processing-output framework. In certain embodiments, these modules are also referred to as DBAU, DIPU, and SU. In further embodiments, each module may comprise one or more instances of DBAU, DIPU, and SU. Additionally, in other embodiments, the “Spatial Domain Module” may specifically refer to an AC with integrated DBAU, DIPU, and SU components.

Components and elements are configured to associate with identifiers, mutually couple, combine, and form adjustable clusters or operate independently, and are operable with an integrated feedback loop, based on a defined task.

For the purposes of this invention, an “Adapter” refers to a component or module that facilitates the integration and interoperability between different frameworks by providing a common interface or bridge. This concept is often referred to as a “Framework adapter,” “framework handler” or “framework connector” in earlier disclosures. Examples of adapters include but are not limited to: Interoperability bridges, Interface connectors, Framework handlers, Integration modules. These adapters enable seamless communication and data exchange between different frameworks, systems, or components, thereby promoting collaboration, efficiency, and innovation.

“Meta-Language” refers to domain-specific language (DSL) and declarative language (including but not limited to JSON/YAML/XML/custom) compiled into execution plans controlling routing, policies, topology, and thresholds with versioning and rollback. A language used to describe or define other languages, enabling higher-level abstraction and meta-programming.

“Structured Meta-Language System (SMLS)” refers to a unified structured meta-language system component in the meta-system that provides consistent and structured programming methods for different systems to improve compatibility and efficiency. The SMLS comprise one or more sub-units, each containing one or more mechanisms or rules that enable adaptive compilation into an executable representation. Adapters integrate one or more frameworks to facilitate seamless interaction with various components. The Structured Meta-Language/domain-specific language (DSL) defines the rules for converting source code and their mutual transformations but does not directly determine the categorization of specific data attributes or execution paths, nor output judgments.

“Quantum-like” refers to a framework or structure that simulates principles of quantum computing, achieving more efficient and scalable processing through parallelism and superposition techniques without adding the complexity of actual quantum bits (qubits).

A “data processing apparatus” encompasses any machine or collection of machines configured to execute instructions for manipulating data, including general-purpose or special-purpose processors, distributed computing resources, and dedicated logic circuitry such as field-programmable gate arrays (FPGAs) and application-specific integrated circuits (ASICs). A computing environment may further comprise firmware, operating systems, protocol stacks, database systems, or runtime engines that collectively support execution of program logic. User interaction may be facilitated through displays, input peripherals, touch interfaces, audio devices, haptic mechanisms, or network-based interfaces accessible via browsers, mobile applications, or other communication clients. Communications between system components may occur over wired or wireless digital networks including, without limitation, local and wide area networks, and the Internet.

In this system's ecosystem, “transition” may emphasize the “movement” rather than the “transformation” of states. This meta-system is configured to dynamically switch between the two approaches for multi-domain coordination and under dynamic meta-learning model.

“Identity-as-the-Perimeter (IatP)” refers to identity verification becoming the primary or sole boundary control point, where all access attempts rely on identity authentication to determine whether to allow entry into network resources. In one or more embodiments, this framework is used for user authentication and authorization, with a user's identity authenticated to determine whether external requests are allowed to enter local network resources. This framework can be performed parallel in forward, backward, and multidimensional directions. In another application scenario, the meta-system uses IatP to construct a resource allocation infrastructure system, where the system accesses data and allocates resources to different nodes through authentication and authorization.

While specific implementations are described to provide a complete understanding of the invention, it will be understood that the invention is not limited to these forms and can be practiced in various alternative forms and configurations. The scope of the invention is intended to encompass all possible implementations, thereby facilitating its utility and versatility.

Elements or functionalities described in one embodiment can be applied to other embodiments, and features shown together may also be used separately or in sub-combinations in alternative embodiments. The claimed subject matter covers all such variations, including changes in ordering, partitioning, or execution of processes.

Additionally, while certain operations may be described in a specific sequence, this is not a limitation unless explicitly stated. Operations may be performed concurrently, in parallel, or in a different order while still achieving the desired results. Multi-threading, asynchronous or synchronous processing, and parallel execution are also applicable. The delineation of components, modules, or services is for conceptual purposes; they may be distributed, integrated, or rearranged in other implementations.

The embodiments disclosed herein are provided for illustrative and enforcement purposes only and should not be interpreted as limiting the scope of the claims except where explicitly required. Functional blocks, units, operations, and architectural arrangements are representative, and the claimed subject matter encompasses structural equivalents, functional replacements, distributed implementations, and computational variations. Features described in relation to a particular embodiment may be combined with features from other embodiments unless technically incompatible.

Conversely, features disclosed together may be practiced individually or in sub-component combinations, and the scope of the claims includes such combinations, decompositions, substitutions, and rearrangements.

In specific embodiments, improvements may be directed towards efficiency, model accuracy, latency reduction, privacy, resource management, or distributed execution. While this disclosure provides specific examples and implementations, these are intended for illustration purposes only and should not limit the scope of the claims. The disclosed features may be combined, modified, or rearranged in various ways unless explicitly stated otherwise.

Embodiments may incorporate secure enclaves, encrypted computation, differential privacy, identity assurance, audit logging, and compliance with data-protection frameworks. Security mechanisms may be centralized or distributed and may leverage cryptographic primitives, hardware-rooted trust, or attestation protocols to enforce the integrity of the system.

Execution shown is non-limiting and does not imply any specific order of steps is required; instead, steps may be reorganized, parallelized, omitted, supplemented, or executed concurrently while achieving the intended functionality unless explicitly stated otherwise. Implementations may include distributed training, federated execution, on-device inference, or heterogeneous acceleration using various hardware and software platforms, including GPUs, TPUs, NPUs, dedicated ML accelerators, trusted execution hardware, or cloud-edge hybrid environments. Parallel processing, model partitioning, pipelined execution, and asynchronous scheduling may be applied to achieve the intended functionality. Software and hardware boundaries described herein are conceptual and do not constrain deployment; instead, processing logic may be consolidated or distributed across networked, virtualized, or hardware-accelerated environments.

The disclosure therefore offers a practical and verifiable contribution, while remaining consistent with statutory requirements for patent protection. Together, these embodiments illustrate that the same underlying technology is domain-agnostic and applicable to multiple industries without limitation.

The detailed description that follows provides an architectural and operational context for the disclosed technology. Specific embodiments are presented for purposes of explanation and clarity. However, these examples are non-limiting, and variations, equivalents, and alternative configurations may be employed without departing from the scope of the claimed subject matter. In some implementations or embodiments, the representations, notations, or symbols may be obtained by applying a mapping function to input data.

The claims shall be construed to cover all implementations supported by the specification, including technological equivalents foreseeable to a person skilled in the art at the filing date, without limitation to any particular embodiment or example described herein.

1. A system comprising:
one or more processors; one or more memory modules with instructions stored therein, which when executed by the one or more processors, cause the processors to:
obtain a first intermediate representation (IR), wherein the first IR represents a computational state;
generate a second intermediate representation (IR) based at least in part on the first intermediate representation (IR);
generate a third intermediate representation (IR) by a predefined method based at least in part on the first IR and the second IR;
update at least one of the first IR or the second IR based a relationship with the first IR and the second IR; and
wherein the first IR, the second IR, and third IR are configured to collectively define a closed feedback loop that maintains the system at a target state under a change in an operating condition.

2. The system of claim 1, wherein generating the third IR comprises determining a correspondence between elements of the first IR and elements of the second IR, based on the relationship between the first IR and the second IR;
wherein updating the first IR and the second IR based on the third IR is configured to modify at least one element of the first IR or the second IR;
wherein updating the first IR and the second IR based on the third IR is configured to cause the change in a subsequent generation of the third IR; and
wherein iteratively generating the third IR and updating the first IR and the second IR continues until a termination condition is satisfied, said termination condition being based on convergence of the third IR.

3. The system of claim 1, wherein the first IR is based on a computing from a first computational module;
wherein the first computational module configured to:
detect a parameter of an operating environment; and
generate the first IR by processing an output of the sensing element;
wherein the first IR is a data object comprising from at least one of:
a timestamp field indicating a time of measurement,
a parameter identifier field indicating which parameter was measured,
a parameter set representing the rules and standards of measurement, and
a value field representing the measured state.

4. The system of claim 1, wherein the second IR is based on a computing from a second computational module;
wherein the second computational module is configured to:
trigger exclusively by receipt of the first IR;
receive the first IR from the first computational module via a unidirectional data path;
combine the first second with reference data to produce fused data; and
generate the second IR by applying a transition or transformation to the fused data;
wherein generation of the second IR by the second computational module is triggered exclusively by receipt of the first IR;
wherein the second computational module is configured to downstream of the first computational module and does not generate the second IR if in an absence of the first IR;
wherein the second computational module comprises a transition engine that has been trained at least in part on a corpus of historical samples; and
wherein each historical sample comprises a historical first IR paired with a corresponding historical second IR representing a known correct inference for that historical first IR.

5. The system of claim 4, wherein the second IR comprises from at least one of:
a probability distribution over a set of candidate states,
a logic chain over a set of candidate states,
a relationship map over a set of candidate states,
a pattern network over a set of candidate states,
a meta-language dictionary over a set of candidate states,
a transition method set over a set of candidate states,
a navigation graph over a set of candidate states, or
other Applicant-defined representation;
wherein each candidate state comprises from at least one of: an associated record, a value, or an identifier; and
wherein the second IR further is configured to identify a highest-probability or a matched candidate state.

6. The system of claim 1, wherein the third IR is based on a computing from a third computational module;
wherein the third computational module configured to:
receive the first IR and the second IR over respective independent IR paths before generating a control decision;
compare a state indicated by the first IR with an inference indicated by the second IR;
incorporate the confidence indicator into the comparison between the first IR and the second IR;
generate the control decision based on a result of the comparison;
generate the control decision based on the second IR when a difference between the state indicated by the first IR and the inference indicated by the second IR is below a divergence threshold;
generate the control decision based on the first IR and disregard the second IR when the difference exceeds the divergence threshold; and
execute a control operation in accordance with the control decision;
wherein the control decision is always a function of both first IR and the second IR.

7. The system of claim 1, wherein the first IR and the second IR represent respective computational states of a program execution;
wherein the first IR represents a measured state of the parameter;
wherein the second IR represents an inference derived from the first IR the inference being distinct from the measured state represented by the first IR; and
wherein the third IR represents an execution of the control operation.

8. The system of claim 1, wherein the closed feedback loop configured to:
alter an operating condition of an environment by the third computational module;
detect the resulting change in a parameter of the environment from the first computational module caused by the control operation; and
generate an updated second IR from the second computational module based on the resulting change detected by the first computational module.

9. The system of claim 1, wherein the system comprises a target state;
wherein the target state is defined by a predetermined operating range of the parameter; and
wherein the third computational module is configured to adjust the control operation to drive the parameter toward the predetermined operating range when the measured state indicated by the first IR falls outside the predetermined operating range.

10. The system of claim 1, wherein the change in the second computational module operating
condition comprises a change in an environmental variable that is distinct from the parameter detected by the first computational module; and
wherein the control computational module is configured to modify a parameter of the control operation to compensate for the change in the environmental variable without altering a functional role of the first computational module, the second computational module, or the third computational module within the closed feedback loop.

11. The system of claim 1, wherein the system is configured to operate in parallel;
wherein upon detection that a proposed update violating a hybrid-time constraint or a policy within any computational module, a rollback within the computational module is configured to be performed to restore a previously validated versioned inference state;
wherein upon policy violation within the computational module is configured to trigger rollback; and
wherein the computational component scheduling is downgraded to a safe mode.

12. The system of claim 1, wherein the system further comprise a reversible adaptive compiler configured to:
monitor a timing of the first IR and a timing of the second IR;
detect a deviation from the closed feedback loop when the second IR is not generated within a pre-determined latency window measured, steps, or authentication identifier from generation of the first IR; and
trigger a fallback, rollback or model update upon detection of any deviation, wherein the third computational module performs the control operation using only the first IR during this fallback rollback or model update;
wherein the adaptive compiler module comprises one or more model-parameter adapters
wherein the more model-parameter adapter is configured to mediate modality conversion;
wherein the adaptive compiler comprise one or more adapters which are configured to mediate modality conversion; and
wherein the adapters are configured to support capability negotiation and versioning at a time control.

13. The system of claim 3, wherein the second computational module is further configured to:
generate, alongside the second IR, a confidence indicator representing a reliability of said inference;
wherein the second computational module is configured to, upon generating the second signal, push the second IR to the third computational module without waiting for a request from the third computational module;
wherein the first computational module is configured to transmit the first IR to the second computational module only when a magnitude of change in the measured state relative to a prior measurement exceeds a significance threshold; and
wherein the second computational module does not re-generate the second IR for insubstantial changes in the measured state.

14. The system of claim 1, wherein the system further comprises one or more input module;
wherein the input module is configured to receive raw data from at least one of: spectroscopy, chromatography, frequency, context, space, time, system logs, thermodynamics, temperature, pressure, emotional entropy, physics, and other disciplines from at least one of: textual tokens, images, audio, video, tabular records, graphs, sensor telemetry and tool-generated intermediate artifacts;
wherein the input data comprising at least one of:
sequences, non-sequences, tensors, non-tensors, graphs of elements or a group of framework adapters and to buffer and marshal the input data into a canonical ingestion format;
wherein the adapters integrate one or more frameworks including:
a machine-learning framework comprising at least one of TensorFlow, PyTorch,
or
an equivalent;
a data-processing framework comprising at least one of Apache Spark, Flink, or
an equivalent; and
an orchestration framework comprising at least one of Kubernetes, Docker Swarm,
or
an equivalent;
wherein the adapters are configured to provide protocol shims for standardized transport and messaging, the protocol shims comprising at least one of gRPC, REST, WebSocket, or MQTT, the adapters further being configured to support hot-swapping and version compatibility;
wherein the protocol specifications, which are adaptive compiled into an executable inference graph, executable plans that modify routing, topology, policies, or thresholds;
wherein the adapters comprise at least one of: input/output protocol adapters, model-parameter adapters, hardware-acceleration adapters, and context adapters that mediate modality conversion;
wherein the adapters support capability negotiation and versioning, are hot-swappable at hybrid-time under safety gates and maintain backward compatibility via declared adapter contracts; and
wherein the execution uses at CPUs, GPUs, TPUs, FPGAs or other Applicant-defined execution method and hardware.

15. The system of claim 12, wherein the adaptive compiler comprises a domain-specific
language (DSL) meta-language system;
wherein the DSL meta-language system is configured to define and compile at least one of task graphs, adapter bindings, and resource constraints into one or more executable representation;
wherein the DSL meta-language system is configured to define an abstract intermediate representation (IR) and a typed operator-and-graph specification of processing blocks, connectors, data types, constraints, budgets, structural configuration, deployment descriptors including container and orchestration manifests;
wherein the system's operations are specified by the DSL meta-language system and vocabulary secured against tampering; and
wherein the DSL meta-language system specifications are version-controlled, cryptographically signed, and tamper-evident recorded.

16. The system of claim 1, wherein the relationship comprises one or more spatiotemporal
energy relationship (SER);
wherein the system further comprises one or more spatiotemporal energy relationship transition methods;
wherein the transition methods configured to:
apply one or more transition functions from narrative transition framework; and
transition one or more corresponding independent network at each of a plurality of input features in an input spatiotemporal energy relationship and to generate an aggregate respective task-specific output of each of the plurality of input features in the input spatiotemporal energy relationship, achieving non-uniform, targeted independently transition output for each feature within the same consistency in associations between various features and Spatiotemporal Energy based on data type;
wherein the plurality of computational modules is arranged in one or more proprietary topologies selected from a group consisting of polymorphic topological configurations (PTC);
wherein the polymorphic topological configurations comprising quantum-like structured, tree, mesh, directed acyclic graph (DAG), ring, hierarchical layered topology or Applicant-defined topology;
wherein the computational modules are interconnected according to a configuration comprising a layered structure, and are arranged into input, intermediate, and output layers defined by functional relationships;
wherein the system operations comprise at least one of: rule-based, graph-based, logic-based, learning-based, proprietary hybrid reasoning strategies or Applicant-defined operation;
wherein any attempt to mimic, alter, or substitute said structural arrangements without validated authorization metadata is automatically rejected by the system, thereby preventing unauthorized reproduction of system architecture; and
wherein graphical or structural representation elements of modules, including flowcharts, block diagrams, or topology schematics, are associated with authorization metadata, and access to derivative reproduction is controlled based on an authorization state derived from the authorization metadata.

17. The system of claim 3, wherein for each of the parameter, the system is configured to
generate a unique version-controlled identifier that is cryptographically signed and tamper-evident;
wherein domain-specific inference parameters comprise domain-relevant features including cryptography support, cross-domain computing integration, audit support, financial risk factors, medical indicators, system governance, legal support, aerospace, handwear design, cyber security, cognitive interaction, educational performance metrics, defense situational attributes, and consumer behavior signals;
wherein for each parameter update, the system is configured to record pre-update and post-update parameter states at the system level, both conditioned on decentralized identifier (DID) authorization; and
wherein the system is configured to maintain a transactional inference record linking successive parameter revisions to ensure integrity and verifiability of the update process.

18. The system of claim 11, wherein the system is configured to generate one or more versioned inference state;
wherein each of the versioned inference state is associated with metadata identifying its version;
wherein the metadata comprises from at least one of: a sequential index, a timestamp, a cryptographic hash, or an Applicant-defined compliance marker;
wherein any update or replication operation without validated authorization metadata is configured to be self-adaptatively rejected;
wherein an update to the inference state within the computational module is performed only after authorization is granted;
wherein rollback operations within the computational module are executed only upon authorized instruction;
wherein the system is configured to verify a version-controlled identifier associated with each parameter set prior to loading, thereby ensuring the authenticity and authorized provenance of the parameters; and
wherein the system is configured for analytical or predictive processing of structured or unstructured data in application domains including, for example, cryptography support, audit support, financial analysis, healthcare diagnostics, legal document support processing, educational performance evaluation, defense data assessment, and consumer behavior analytics.

19. The system of claim 1, the system further comprises one or more cryptography mechanisms configured to:
apply one or more transition functions from narrative transition framework;
converting computational resources into standardized execution containers;
organizing scattered resources and allocating resources based on tasks;
providing flexible expansion capabilities for scalable execution components to achieve dynamic scalability for different computational environment;
invoking narrative method, wherein invoking narrative method comprise:
extracting the features, pattern, and spatiotemporal energy relationship of the multimodal data;
applying the DSL meta-language system to all the executions;
integrating cross-dimensional methods for align with one or more logical chains;
tracing the logical chains based on target intentions of the multimodal input; and
self-adaptatively removing unnecessary information, logics, value, features, pattern, and spatiotemporal energy relationship of the multimodal data, maintain system efficiency and adjust storage resource usage dynamically;
converting the uploaded data into structured data according to a predefined schema;
encrypting at least a portion of the structured data using a cryptographic algorithm;
recording the encrypted structured data on-chain in an immutable manner;
tracking provenance and lineage of the structured data across the distributed ledger; and
enabling submission, querying, and verification of the structured data.

20. The system of claim 1, wherein at least one computational module or model of the system is implemented in a custom hardware circuit configured to perform its designated tasks;
wherein at least one computational module of the system is implemented in a custom computational module of the system is implemented in a virtualized execution environment, including virtual machines, containers, or cloud-based computational resources;
wherein at least one computational module of the system is implemented in a combination of hardware, software, firmware, and virtualized resources;
wherein at least one computational module of the system is implemented in custom hardware, while others are implemented in virtualized or software-based environments, and the system dynamically manages all modules according to its orchestration mechanism;
wherein the system further comprises one or more mechanisms from at least one of world model, self-developing consciousness, spatiotemporal energy relationship transition, gestation, compliance, narrative cryptography, or Applicant-defined mechanism;
wherein each mechanism of the system may be implemented in custom hardware circuits, including ASICs, FPGAs, neuromorphic chips, or any future hardware devices;
wherein each mechanism of the system may be implemented in software, firmware, virtual machines, containers, or cloud-based computational resources;
wherein each mechanism of the system may be implemented in a combination of hardware, software, firmware, virtualized resources, or presently known or later-developed hardware technologies; and
wherein the mechanism may dynamically generate, remove, or reconfigure computational modules in real-time, adapting to changing inputs, system states, or computational environments, including presently known or later-developed implementations.

21. The system of claim 1, wherein the second module further includes a learning algorithm
module that is trained to long-term, self-adaptive operation and fusion of multiple sensor sources to drive a continuous process;
wherein the module is configured to be used for predictive analytics in industries such as Compliance Auditing, Judicial Arbitration, Traffic Signal and Control, Process Industry, Multi-Source Input Resource Integration, Rotating Machinery Health Management, Future-tech; and
wherein the system is deployed as a cloud-based application that can be accessed via multiple devices and is adaptable to different devices and platforms for use in Finance, Defense, Education, Blockchain, Cryptocurrency, Aerospace, Cognitive Asset Architecture and Foundation.

22. The system of claim 1, wherein the method is an inference rule and self-adaptive-learning model that adapts based on real-time interaction data and feedback to improve the accuracy of the output;
wherein the system comprises:
a server configured to host the software module and process the input data;
an interface that allows users or systems to input data and receive output; and
wherein the system is adaptable for deployment in multiple industries, including Governance, Multi-Dimensional Transition, Cyber Security, Cryptography, Life Sciences, Rehabilitation and Reconstruction by customizing the input-output interface and processing logic based on specific industry needs.

23. A computer-implemented method comprising:
obtain a first intermediate representation (IR), wherein the first IR represents a computational state;
generate a second intermediate representation (IR) based at least in part on the first intermediate representation (IR);
generate a third intermediate representation (IR) by a predefined method based at least in part on the first IR and the second IR;
update at least one of the first IR or the second IR based a relationship with the first IR and the second IR; and
wherein the first IR, the second IR, and third IR are configured to collectively define a closed feedback loop that maintains the system at a target state under a change in an operating condition.

24. A non-transitory computer-readable storage medium storing instructions that, when
executed by one or more processors; one or more memory modules with instructions stored therein, which when executed by the one or more processors, cause the processor to:
obtain a first intermediate representation (IR), wherein the first IR represents a computational state;
generate a second intermediate representation (IR) based at least in part on the first intermediate representation (IR);
generate a third intermediate representation (IR) by a predefined method based at least in part on the first IR and the second IR;
update at least one of the first IR or the second IR based a relationship with the first IR and the second IR; and
wherein the first IR, the second IR, and third IR are configured to collectively define a closed feedback loop that maintains the system at a target state under a change in an operating condition.
